(19) United States
(12) Patent Application Publication
(10) Pub. No.: US 2012/0287181 A1
(43) Pub. Date: Nov. 15, 2012

(54) PLASMA DISPLAY DEVICE AND METHOD FOR DRIVING PLASMA DISPLAY PANEL

(76) Inventors: Jun Kamiyamaguchi, Osaka (JP); Masahiro Yamada, Osaka (JP)

(21) Appl. No.: 13/519,277

(22) PCT Filed: Jan. 12, 2011
(86) PCT No.: PCT/JP2011/000083

§ 371 Date: Jun. 26, 2012

(30) Foreign Application Priority Data
Jan. 12, 2010 (JP) 2010-003748

(51) Int. Cl. G09G 3/28; G09G 5/10

(52) U.S. Cl. 345/691; 345/63

(57) ABSTRACT

The image display quality of the plasma display apparatus is improved. For this purpose, the plasma display apparatus corrects the number of generated sustain pulses in each subfield using a first correction coefficient that is read from look-up table (62) in response to the all-cell light-emitting rate and the partial light-emitting rates and a common correction coefficient. The apparatus adds preset offset value OFST to the all-cell light-emitting rate, multiplies the addition result by the number of sustain pulses in each subfield, and calculates the sum total of the multiplication results in one field period to calculate an estimated value of the power consumption in one field period. The apparatus sets the common correction coefficient so that the estimated value of the power consumption in one field period before the correction using the first correction coefficient and the common correction coefficient is equivalent to that after the correction.

### TECHNICAL FIELD

The present invention relates to a plasma display apparatus and a driving method of a plasma display panel that are used in a wall-mounted television or a large monitor.

### BACKGROUND ART

An alternating-current surface discharge type panel typical as a plasma display panel (hereinafter referred to as “panel”) has many discharge cells between a front substrate and a rear substrate that are faced to each other.

The front substrate has the following elements:
a plurality of display electrode pairs disposed in parallel on a front glass substrate; and
a dielectric layer and protective layer disposed so as to cover the display electrode pairs.
   Here, each display electrode pair is formed of a pair of scan electrode and sustain electrode.

The rear substrate has the following elements:
a plurality of data electrodes disposed in parallel on a rear glass substrate;
a dielectric layer disposed so as to cover the data electrodes;
a plurality of barrier ribs disposed on the dielectric layer in parallel with the data electrodes; and
phosphor layers disposed on the surface of the dielectric layer and on side surfaces of the barrier ribs.

The front substrate and rear substrate are faced to each other so that the display electrode pairs and the data electrodes three-dimensionally intersect, and are sealed. Discharge gas containing xenon with a partial pressure ratio of 5%, for example, is filled into a discharge space in the sealed product. Discharge cells are disposed in intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color image display.

A subfield method is generally used as a method of driving the panel. In this subfield method, one field is divided into a plurality of subfields, and light is emitted or light is not emitted in each discharge cell in each subfield, thereby performing gradation display. Each subfield has an initializing period, an address period, and a sustain period.

In the initializing period, an initializing waveform is applied to each scan electrode, and initializing discharge is caused in each discharge cell. Thus, wall charge required for a subsequent address operation is produced in each discharge cell, and a priming particle (an excitation particle for causing address discharge) for stably causing address discharge is generated.

In the address period, a scan pulse is sequentially applied to scan electrodes (hereinafter, this operation is also referred to as “scan”), and an address pulse is selectively applied to data electrodes based on an image signal to be displayed. Thus, address discharge is caused between the scan electrode and the data electrode of the discharge cell to emit light, thereby producing wall charge in the discharge cell (hereinafter, this operation is also collectively referred to as “address”).

In a sustain period, as many sustain pulses as a number determined for each subfield are alternately applied to the display electrode pairs formed of the scan electrodes and the sustain electrodes. Thus, sustain discharge is caused in the discharge cell having undergone address discharge, thereby emitting light in the phosphor layer of this discharge cell (hereinafter, light emission by sustain discharge in a discharge cell is referred to as “lighting”, and no light emission is referred to as “no-lighting”). Thus, light is emitted in each discharge cell at a luminance corresponding to the luminance weight that is determined for each subfield. Thus, light is emitted in each discharge cell of the panel at a luminance corresponding to the generation value of the image signal, and an image is displayed on the image display surface of the panel.

As one of subfield methods, the following driving method is used. In the initializing period of one of a plurality of subfields, an all-cell initializing operation of causing initializing discharge in all discharge cells is performed. In the initializing periods of other subfields, a selective initializing operation of causing initializing discharge only in the discharge cell having undergone sustain discharge in the sustain period immediately before it is performed. Thus, the luminance (hereinafter, referred to as “luminance of black level”) in a black displaying region that does not cause sustain discharge is only weak light emission in the all-cell initializing operation. Therefore, light emission that is not related to the gradation display can be minimized, and the contrast ratio of the display image can be increased.

When the driving load (impedance when a driver circuit applies driving voltage to an electrode) differs between display electrode pairs, voltage drop of the driving voltage differs between them, and the emission luminance can differ between discharge cells though image signals have the same luminance. A technology is therefore disclosed where the lighting pattern is made to differ between subfields in one field when the driving load differs between display electrode pairs (for example, Patent Literature 1).

Recently, as the screen of the panel is enlarged and the definition is enhanced, the driving load of the panel is apt to increase. In such a panel, the difference in driving load between display electrode pairs is apt to increase, and the difference in voltage drop of the driving voltage is also apt to increase.

When the driving load differs between subfields, emission luminance caused by one sustain discharge differs between the subfields. When the panel is driven by the subfield method, as discussed above, one field period is divided into a plurality of subfields, and gradation display is performed by combination of the subfields to emit light. Therefore, when the emission luminance caused by one sustain discharge differs between subfields, the linearity of the gradation can be damaged.

In the panel where the driving load is increased by the enlargement of the screen and the enhancement of the definition, the difference in driving load between subfields is apt to increase and the difference in emission luminance between subfields is apt to occur, so that the linearity of the gradation is apt to be damaged. On such a panel, in order to display an image where the linearity of the gradation is kept, it is preferable that the luminance of each subfield is controlled optimally in response to the difference in emission luminance between subfields.

In the panel where the screen is enlarged and the definition is enhanced, it is desired that the image display quality of the plasma display apparatus is further improved. The brightness of the image to be displayed on the panel is one factor for determining the image display quality. Therefore, preferably, variation in brightness of the display image is minimized when correction such as alteration of the lighting pattern of a subfield is performed.

### CITATION LIST

### Patent Literature

PTL 1

Unexamined Japanese Patent Publication No. 2006-184843

### SUMMARY OF THE INVENTION

A plasma display apparatus of the present invention includes the following elements:
a panel having a plurality of discharge cells where a plurality of subfields having a luminance weight is disposed in one field and as many sustain pulses as a number corresponding to the luminance weight are applied in the sustain period of each subfield to emit light;
an image signal processing circuit for converting an input image signal into image data that indicates light emission or no light emission in each subfield in the discharge cells;
a sustain pulse generation circuit that generates as many sustain pulses as the number corresponding to the luminance weight in the sustain period, and applies them to the discharge cells;
an all-cell light-emitting rate detecting circuit for detecting, as an all-cell light-emitting rate, which is a ratio of the number of discharge cells to be lit to a total number of discharge cells on the image display surface of the panel in each subfield; and
a partial light-emitting rate detecting circuit that divides the image display surface of the panel into a plurality of regions and detects, as a partial light-emitting rate, which is a ratio of the number of discharge cells to be lit to the number of discharge cells in each subfield in each of the regions; and
a timing generation circuit that has a number-of-sustain-pulses correcting section for controlling the number of sustain pulses generated by the sustain pulse generation circuit and generates a timing signal for controlling the sustain pulse generation circuit.
   The number-of-sustain-pulses correcting section has a look-up table on which a plurality of correction coefficients is previously stored in association with the all-cell light-emitting rate and the partial light-emitting rates. The number-of-sustain-pulses correcting section corrects the number of generated sustain pulses set for each subfield based on the input image signal and the luminance weight by using the following correction coefficients:
a first correction coefficient that is read from the look-up table in response to the all-cell light-emitting rate and the partial light-emitting rates and is set for each subfield; and
a common correction coefficient set based on the first correction coefficient.
   The number-of-sustain-pulses correcting section adds a preset offset value to the all-cell light-emitting rate in each subfield, multiplies the addition result by the number of sustain pulses in each subfield, and calculates the sum total of the multiplication results in one field period, thereby calculating an estimated value of the power consumption in one field period. The number-of-sustain-pulses correcting section sets the common correction coefficient so that the estimated value of the power consumption in one field period before the correction using the first correction coefficient and the common correction coefficient is equivalent to that after the correction.

Thus, variation in emission luminance between subfields can be accurately estimated by detecting the all-cell light-emitting rate and the partial light-emitting rates. And, the number of generated sustain pulses set based on the input image signal and luminance weigh can be corrected using the first correction coefficient responsive to the all-cell light-emitting rate and the partial light-emitting rates. The number of generated sustain pulses can be controlled using the common correction coefficient that can make the estimated value of the power consumption in one field period before the correction equivalent to that after the correction. Thus, even in the panel where the screen is enlarged and the definition is enhanced, the linearity of the gradation in the display image can be kept, and the brightness of the display image can be controlled while the increase in power consumption is suppressed, so that the image display quality of the plasma display apparatus can be improved.

In a driving method of a panel of the present invention, the panel emits light in discharge cells by disposing a plurality of subfields, each of which has a luminance weight in one field and applying as many sustain pulses as the number corresponding to the luminance weight to the discharge cells in the sustain period.

The driving method includes the following steps:
detecting, as an all-cell light-emitting rate, which is a ratio of the number of discharge cells to be lit to a total number of discharge cells on the image display surface of the panel in each subfield, dividing the image display surface of the panel into a plurality of regions, and detecting, as a partial light-emitting rate, which is a ratio of the number of discharge cells to be lit to the number of discharge cells in each of the regions in each subfield;
correcting the number of generated sustain pulses set for each subfield based on an input image signal and the luminance weight by using a first correction coefficient that is determined based on the all-cell light-emitting rate and the partial light-emitting rates and a common correction coefficient that is set based on the first correction coefficient;
adding a preset offset value to the all-cell light-emitting rate in each subfield, multiplying the addition result by the number of sustain pulses in each subfield, and calculating the sum total of the multiplication results in one field period, thereby calculating an estimated value of the power consumption in one field period; and
setting the common correction coefficient so that the estimated value of the power consumption in one field period before the correction using the first correction coefficient and the common correction coefficient is equivalent to that after the correction.

Thus, variation in emission luminance between subfields can be accurately estimated by detecting the all-cell light-emitting rate and the partial light-emitting rates, and the number of generated sustain pulses set based on the input image signal and luminance weigh can be corrected using the first correction coefficient responsive to the all-cell light-emitting rate and the partial light-emitting rates. The number of generated sustain pulses can be controlled using the common correction coefficient that can make the estimated value of the power consumption in one field period before the correction equivalent to that after the correction. Thus, even in the panel where the screen is enlarged and the definition is enhanced, the linearity of the gradation in the display image can be kept, and the brightness of the display image can be controlled while the increase in power consumption is suppressed, so that the image display quality of the plasma display apparatus can be improved.

### BRIEF DESCRIPTION OF DRAWINGS

FIG. 1 is an exploded perspective view showing a structure of a panel in accordance with a first exemplary embodiment of the present invention.

FIG. 2 is an electrode array diagram of the panel in accordance with the first exemplary embodiment of the present invention.

FIG. 3 is a waveform chart of driving voltage applied to each electrode of the panel in accordance with the first exemplary embodiment of the present invention.

FIG. 4 is a circuit block diagram of a plasma display apparatus in accordance with the first exemplary embodiment of the present invention.

FIG. 5 is a circuit diagram showing the configuration of a scan electrode driver circuit of the plasma display apparatus in accordance with the first exemplary embodiment of the present invention.

FIG. 6 is a circuit diagram showing the configuration of a sustain electrode driver circuit of the plasma display apparatus in accordance with the first exemplary embodiment of the present invention.

FIG. 7A is a schematic diagram for illustrating difference in emission luminance caused by variation in driving load.

FIG. 7B is a schematic diagram for illustrating difference in emission luminance caused by variation in driving load.

FIG. 8A is a schematic diagram for illustrating another example of difference in emission luminance caused by variation in driving load.

FIG. 8B is a schematic diagram for illustrating another example of difference in emission luminance caused by variation in driving load.

FIG. 9 is a diagram for schematically showing measurement of the emission luminance performed for setting correction coefficients in accordance with the first exemplary embodiment of the present invention.

FIG. 10 is a diagram showing one example of the correction coefficients in accordance with the first exemplary embodiment of the present invention.

FIG. 11 is a circuit block diagram of a number-of-sustain-pulses correcting section in accordance with the first exemplary embodiment of the present invention.

FIG. 12 is a diagram showing a part of circuit blocks of a timing generation circuit in accordance with a second exemplary embodiment of the present invention.

FIG. 13 is a diagram for illustrating “second correction” using a specific numerical value in accordance with the second exemplary embodiment of the present invention. FIG. 14 is a diagram showing a part of circuit blocks of a timing generation circuit in accordance with a third exemplary embodiment of the present invention.

FIG. 15 is a diagram for illustrating “third correction” using a specific numerical value in accordance with the third exemplary embodiment of the present invention.

FIG. 16 is a circuit block diagram of a plasma display apparatus in accordance with a fourth exemplary embodiment of the present invention.

FIG. 17 is a diagram showing a part of circuit blocks of a timing generation circuit in accordance with the fourth exemplary embodiment of the present invention.

FIG. 18 is a diagram showing one example of setting of variable k in accordance with the fourth exemplary embodiment of the present invention.

FIG. 19 is a characteristic diagram showing the relationship between the all-cell light-emitting rate and sustain current of the plasma display apparatus.

FIG. 20 is a diagram showing a part of circuit blocks of a timing generation circuit in accordance with a fifth exemplary embodiment of the present invention.

FIG. 21 is a diagram for illustrating one example of more accurate “third correction” using a specific numerical value in accordance with the fifth exemplary embodiment of the present invention.

### DESCRIPTION OF EMBODIMENTS

A plasma display apparatus in accordance with exemplary embodiments of the present invention will be described hereinafter with reference to the accompanying drawings.

### First Exemplary Embodiment

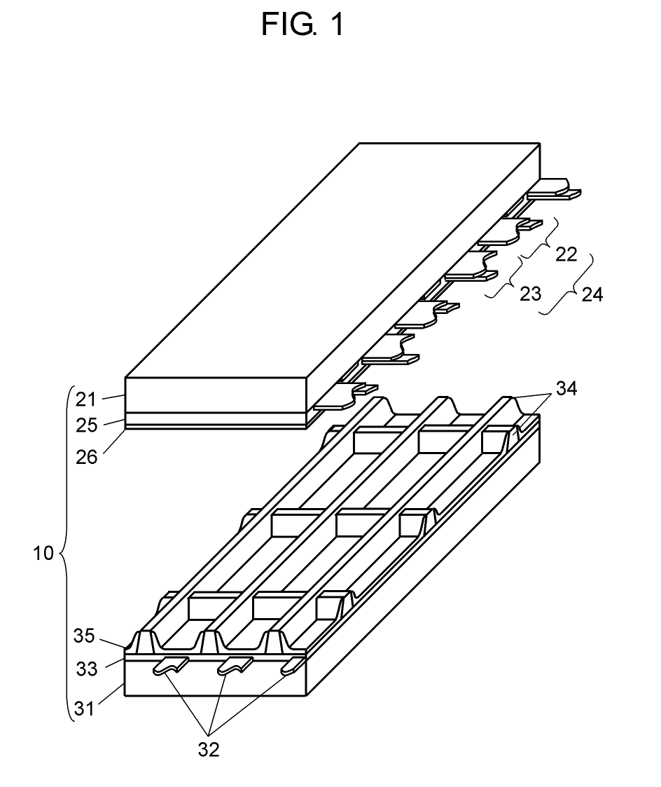

FIG. 1 is an exploded perspective view showing the structure of panel 10 in accordance with a first exemplary embodiment of the present invention. A plurality of display electrode pairs 24 formed of scan electrodes 22 and sustain electrodes 23 is disposed on glass-made front substrate 21. Dielectric layer 25 is formed so as to cover scan electrodes 22 and sustain electrodes 23, and protective layer 26 is formed on dielectric layer 25. Protective layer 26 is made of a material mainly made of magnesium oxide (MgO).

A plurality of data electrodes 32 is formed on rear substrate 31, dielectric layer 33 is formed so as to cover data electrodes 32, and mesh barrier ribs 34 are formed on dielectric layer 33. Phosphor layers 35 for emitting light of each of red color (R), green color (G), and blue color (B) are formed on the side surfaces of barrier ribs 34 and on dielectric layer 33.

Front substrate 21 and rear substrate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example. In the present exemplary embodiment, discharge gas with a xenon partial pressure of 10% is used for improving the luminous efficiency

The discharge space is partitioned into a plurality of sections by barrier ribs 34. Discharge cells are formed in the intersecting parts of display electrode pairs 24 and data electrodes 32. Then, discharge is caused and light is emitted (lighting) in the discharge cells, thereby displaying a color image on panel 10.

In panel 10, one pixel is formed of three consecutive discharge cells arranged in the extending direction of display electrode pairs 24. The three discharge cells are a discharge cell for emitting light of red color (R), a discharge cell for emitting light of green color (G), and a discharge cell for emitting light of blue color (B). Hereinafter, a discharge cell for emitting light of red color is called an R discharge cell, a discharge cell for emitting light of green color is called a G discharge cell, and a discharge cell for emitting light of blue color is called a B discharge cell.

The structure of panel 10 is not limited to the above-mentioned one, but may be a structure having striped barrier ribs, for example. The mixing ratio of the discharge gas is not limited to the above-mentioned one, but may be another mixing ratio.

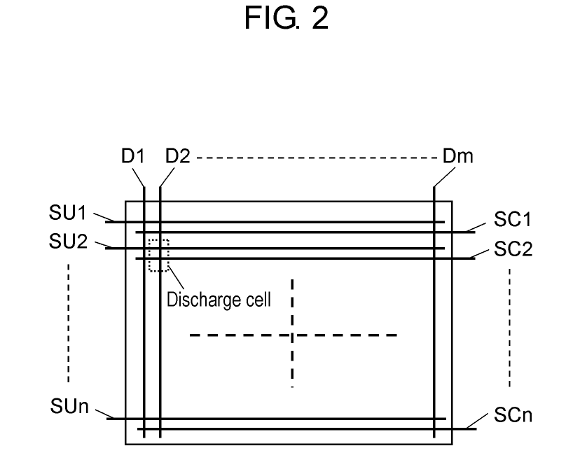

FIG. 2 is an electrode array diagram of panel 10 in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both extended in the row direction, and m data electrode D1 through data electrode Dm (data electrodes 32 in FIG. 1) extended in the column direction. A discharge cell is formed in the part where a pair of scan electrode SCi (i is 1 through n) and sustain electrode SUi intersect with one data electrode Dj (j is 1 through m). In other words, on one display electrode pair 24, m discharge cells are formed and m/3 pixels are formed. Thus, m×n discharge cells are formed in the discharge space, the region having m×n discharge cells defines the image display surface of panel 10. In the panel where the number of pixels is 1920×1080, for example, m is 1920×3 and n is 1080.

Next, a driving voltage waveform and operation for driving panel 10 are described schematically. The plasma display apparatus of the present exemplary embodiment performs gradation display by a subfield method. In this subfield method, the plasma display apparatus divides one field into a plurality of subfields on the time axis, and sets luminance weight for each subfield. An image is displayed on panel 10 by controlling light emission and no light emission in each discharge cell of each subfield.

The luminance weight means the ratio between the luminances displayed in respective subfields, and as many sustain pulses as the number corresponding to the luminance weight are generated in each subfield in the sustain period. For example, in the subfield of luminance weight “8”, as many sustain pulses as the number eight times that in the subfield of luminance weight “1” are generated in the sustain period, and as many sustain pulses as the number four times that in the subfield of luminance weight “2” are generated in the sustain period. Therefore, in the subfield of luminance weight “8”, light is emitted at a luminance about eight times that in the subfield of luminance weight “1” and light is emitted at a luminance about four times that in the subfield of luminance weight “2”. As a result, various gradations can be displayed by selectively emitting light in each subfield using a combination corresponding to the image signal, and an image can be displayed.

In the present exemplary embodiment, a structure example is described where one field is formed of 8 subfields (first SF, second SF, . . . , eighth SF), and the respective subfields have luminance weights of (1, 2, 4, 8, 16, 32, 64, 128) so that the luminance weights sequentially increase as subfields are sequentially generated. In this structure, each of the R signal, G signal, and B signal is displayed at 256 gradations (0 through 255).

In the initializing period of one of a plurality of subfields, an all-cell initializing operation of causing initializing discharge in all discharge cells is performed. In the initializing periods of the other subfields, a selective initializing operation of selectively causing initializing discharge in the discharge cell having undergone sustain discharge in the sustain period in the immediately preceding subfield is performed. Thus, the light emission related to no gradation display is minimized, the emission luminance in a black region that does not cause sustain discharge is reduced, and the contrast ratio of the image displayed on panel 10 can be improved. Hereinafter, the subfield for performing the all-cell initializing operation is referred to as “all-cell initializing subfield”, and the subfield for performing the selective initializing operation is referred to as “selective initializing subfield”.

In the present exemplary embodiment, an example is described where the all-cell initializing operation is performed in the initializing period of the first SF and the selective initializing operation is performed in the initializing periods of the second SF through eighth SF. Thus, the light emission related to no image display is only light emission following the discharge of the all-cell initializing operation in the first SF. Therefore, the luminance of black level, which is luminance in a black displaying region that does not cause sustain discharge, is therefore determined only by weak light emission in the all-cell initializing operation. An image of sharp contrast can be displayed on panel 10.

In the sustain period of each subfield, as many sustain pulses as the number derived by multiplying the luminance weight of each subfield by a predetermined proportionality constant are applied to each of display electrode pairs 24. This proportionality constant is luminance magnification.

In the present exemplary embodiment, when the luminance magnification is one, four sustain pulses are generated in the sustain period of the subfield of luminance weight “2”, and two sustain pulses are applied to each of scan electrode 22 and sustain electrode 23. In other words, in the sustain period, as many sustain pulses as the number derived by multiplying the luminance weight of each subfield by a predetermined luminance magnification are applied to each of scan electrode 22 and sustain electrode 23. Therefore, when the luminance magnification is two, the number of sustain pulses generated in the sustain period of the subfield of luminance weight “2” is eight. When the luminance magnification is three, the number of sustain pulses generated in the sustain period of the subfield of luminance weight “2” is 12.

In the present exemplary embodiment, however, the number of subfields constituting one field and the luminance weight of each subfield are not limited to the above-mentioned numerical values. The subfield structure may be changed based on an image signal or the like.

In the present exemplary embodiment, the number of generated sustain pulses is altered in response to the light-emitting rates of each subfield detected by all-cell light-emitting rate detecting circuit 46 and partial light-emitting rate detecting circuit 47 that are described later. Here, each of the light-emitting rates means the ratio of the number of discharge cells to be lit to a predetermined number of discharge cells. Thus, the linearity of the gradation in the display image on panel 10 is kept, and the image display quality is improved. Hereinafter, the outline of the driving voltage waveforms and the configuration of driver circuits are firstly described, and then a configuration for controlling the number of generated sustain pulses in response to the light-emitting rates is described.

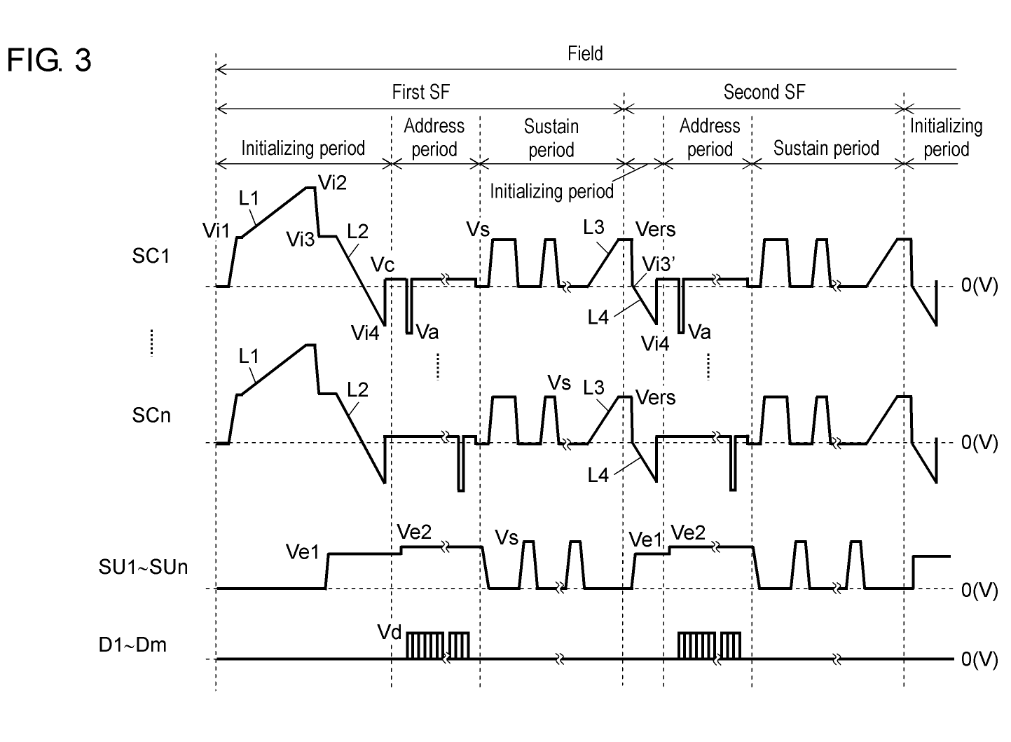

FIG. 3 is a waveform chart of driving voltage applied to each electrode of panel 10 in accordance with the first exemplary embodiment of the present invention. FIG. 3 shows driving voltage waveforms applied to scan electrode

SC1 for firstly performing an address operation in the address period, scan electrode SCn for finally performing the address operation in the address period, sustain electrode SU1 through sustain electrode SUn, and data electrode D1 through data electrode Dm.

FIG. 3 also shows driving voltage waveforms in two subfields. The two subfields include a first subfield (first SF) as the all-cell initializing subfield and a second subfield (second SF) as the selective initializing subfield. The driving voltage waveforms in the other subfields are the same as the driving voltage waveform in the second SF except for the number of generated sustain pulses in the sustain period. Each of scan electrode SCi, sustain electrode SUi, and data electrode Dk discussed later means an electrode that is selected from each kind of electrodes based on image data (which indicates lighting or no-lighting in each subfield).

First, the first SF, which is an all-cell initializing subfield, is described.

In the first half of the initializing period of the first SF, voltage 0 (V) is applied to data electrode D1 through data electrode Dm and sustain electrode SU1 through sustain electrode SUn. Voltage Vi1 is applied to scan electrode SC1 through scan electrode SCn. Voltage Vi1 is set at a voltage lower than the discharge start voltage with respect to sustain electrode SU1 through sustain electrode SUn. Then, a ramp waveform voltage, which gently increases from voltage Vi1 to voltage Vi2, is applied to scan electrode SC1 through scan electrode SCn. Hereinafter, the ramp waveform voltage is referred to as “up-ramp voltage L1”. Voltage Vi2 is set at a voltage exceeding the discharge start voltage with respect to sustain electrode SU1 through sustain electrode SUn. As one example of the gradient of up-ramp voltage L1, a numerical value of about 1.3 V/μsec can be used.

While up-ramp voltage L1 increases, feeble initializing discharge continuously occurs between scan electrode SC1 through scan electrode SCn and sustain electrode SU1 through sustain electrode SUn, and feeble initializing discharge continuously occurs between scan electrode SC1 through scan electrode SCn and data electrode D1 through data electrode Dm. Then, negative wall voltage is accumulated on scan electrode SC1 through scan electrode SCn, and positive wall voltage is accumulated on data electrode D1 through data electrode Dm and sustain electrode SU1 through sustain electrode SUn. The wall voltage on the electrode means voltage generated by the wall charge accumulated on the dielectric layer for covering the electrodes, the protective layer, or the phosphor layers.

In the latter half of the initializing period, positive voltage Ve1 is applied to sustain electrode SU1 through sustain electrode SUn, and voltage 0 (V) is applied to data electrode D1 through data electrode Dm. Ramp waveform voltage, which gently decreases from voltage Vi3 to negative voltage Vi4, is applied to scan electrode SC 1 through scan electrode SCn. Hereinafter, this ramp waveform voltage is referred to as “down-ramp voltage L2”. Voltage Vi3 is set at a voltage lower than the discharge start voltage with respect to sustain electrode SU1 through sustain electrode SUn, and voltage Vi4 is set at a voltage exceeding the discharge start voltage. As one example of the gradient of down-ramp voltage L2, a numerical value of about −2.5 V/μsec can be used.

While down-ramp voltage L2 is applied to scan electrode SC1 through scan electrode SCn, feeble initializing discharge occurs between scan electrode SC1 through scan electrode SCn and sustain electrode SU1 through sustain electrode SUn, and feeble initializing discharge occurs between scan electrode SC1 through scan electrode SCn and data electrode D1 through data electrode Dm. Then, the negative wall voltage accumulated on scan electrode SC1 through scan electrode SCn and the positive wall voltage accumulated on sustain electrode SU 1 through sustain electrode SUn are reduced, and the positive wall voltage accumulated on data electrode D1 through data electrode Dm is adjusted to a value suitable for an address operation. Thus, the all-cell initializing operation of causing initializing discharge in all discharge cells is completed.

In the subsequent address period, scan pulses of voltage Va are sequentially applied to scan electrode SC 1 through scan electrode SCn. An address pulse of positive voltage Vd is applied to data electrode Dk corresponding to the discharge cell to emit light, of data electrode D1 through data electrode Dm. Thus, address discharge is selectively caused to each discharge cell.

Specifically, voltage Ve2 is firstly applied to sustain electrode SU1 through sustain electrode SUn, and voltage Vc is applied to scan electrode SC1 through scan electrode SCn. Then, a scan pulse of negative voltage Va is applied to scan electrode SC1 in the first row, and an address pulse of positive voltage Vd is applied to data electrode Dk of the discharge cell to emit light in the first row, of data electrode D1 through data electrode Dm. At this time, the voltage difference in the intersecting part of data electrode Dk and scan electrode SC1 is derived by adding the difference between the wall voltage on data electrode Dk and that on scan electrode SC1 to the difference (voltage Vd−voltage Va) of the external applied voltage. Thus, the voltage difference between data electrode Dk and scan electrode SC1 exceeds the discharge start voltage, and discharge occurs between data electrode Dk and scan electrode SC1.

Since voltage Ve2 is applied to sustain electrode SU1 through sustain electrode SUn, the voltage difference between sustain electrode SU1 and scan electrode SC1 is derived by adding the difference between the wall voltage on sustain electrode SU1 and that on scan electrode SC1 to the difference (voltage Ve2−voltage Va) of the external applied voltage. At this time, by setting voltage Ve2 at a voltage value slightly lower than the discharge start voltage, a state where discharge does not occur but is apt to occur can be caused between sustain electrode SU1 and scan electrode SC1.

Therefore, the discharge occurring between data electrode Dk and scan electrode SC1 can cause discharge between sustain electrode SU1 and scan electrode SC1 that exist in a region crossing data electrode Dk. Thus, address discharge occurs in the discharge cell to emit light, positive wall voltage is accumulated on scan electrode SC1, negative wall voltage is accumulated on sustain electrode SU1, and negative wall voltage is also accumulated on data electrode Dk.

Thus, the address operation is performed where address discharge is caused in the discharge cell to emit light in the first row and wall voltage is accumulated on each electrode. The voltage in the part where scan electrode SC1 intersects with data electrode 32 to which no address pulse has been applied does not exceed the discharge start voltage, so that address discharge does not occur. This address operation is performed until it reaches the discharge cell in the n-th row, and the address period is completed.

In the subsequent sustain period, as many sustain pulses as the number derived by multiplying the luminance weight by a predetermined luminance magnification are alternately applied to display electrode pairs 24, sustain discharge is caused in the discharge cell having undergone the address discharge, and light is emitted in the discharge cell.

In the sustain period, firstly, a sustain pulse of positive voltage Vs is applied to scan electrode SC1 through scan electrode SCn, and ground potential as base potential, namely 0 (V), is applied to sustain electrode SU1 through sustain electrode SUn. In the discharge cell having undergone address discharge, the voltage difference between scan electrode SCi and sustain electrode SUi is obtained by adding the difference between the wall voltage on scan electrode SCi and that on sustain electrode SUi to voltage Vs of the sustain pulses.

Thus, the voltage difference between scan electrode SCi and sustain electrode SUi exceeds the discharge start voltage, and sustain discharge occurs between scan electrode SCi and sustain electrode SUi. Ultraviolet rays generated by this discharge cause phosphor layer 35 to emit light. By this discharge, negative wall voltage is accumulated on scan electrode SCi, and positive wall voltage is accumulated on sustain electrode SUi. Positive wall voltage is also accumulated on data electrode Dk. In the discharge cell having undergone no address discharge in the address period, sustain discharge does not occur, and the wall voltage at the completion of the initializing period is kept.

Subsequently, 0 (V) as base potential is applied to scan electrode SC1 through scan electrode SCn, and a sustain pulse is applied to sustain electrode SU1 through sustain electrode SUn. In the discharge cell having undergone the sustain discharge, the voltage difference between sustain electrode SUi and scan electrode SCi exceeds the discharge start voltage. Thus, sustain discharge occurs between sustain electrode SUi and scan electrode SCi again, negative wall voltage is accumulated on sustain electrode SUi, and positive wall voltage is accumulated on scan electrode SCi.

Hereinafter, similarly, as many sustain pulses as the number derived by multiplying the luminance weight by the luminance magnification are alternately applied to scan electrode SC1 through scan electrode SCn and sustain electrode SU1 through sustain electrode SUn. Thus, sustain discharge is continuously caused in the discharge cell having undergone the address discharge in the address period.

After generation of a sustain pulse in the sustain period, in the state where voltage 0 (V) is applied to sustain electrode SU1 through sustain electrode SUn and data electrode D1 through data electrode Dm, ramp waveform voltage, which gently increases from 0 (V) to voltage Vers, is applied to scan electrode SC1 through scan electrode SCn. Hereinafter, the ramp waveform voltage is referred to as “erasing ramp voltage L3”.

The gradient of erasing ramp voltage L3 is set to be steeper than that of up-ramp voltage L1. As one example of the gradient of erasing ramp voltage L3, a numerical value of about 10 V/μsec can be used. When voltage Vers is set at a voltage exceeding the discharge start voltage, feeble discharge occurs between sustain electrode SUi and scan electrode SCi in the discharge cell having undergone sustain discharge. This feeble discharge continuously occurs while the voltage applied to scan electrode SC1 through scan electrode SCn increases beyond the discharge start voltage.

Charged particles generated by the feeble discharge are accumulated on sustain electrode SUi and scan electrode SCi so as to reduce the voltage difference between sustain electrode SUi and scan electrode SCi. Therefore, in the discharge cell having undergone the sustain discharge, a part or the whole of the wall voltages on scan electrode SCi and sustain electrode SUi is erased while the positive wall voltage is left on data electrode Dk. In other words, the discharge caused by erasing ramp voltage L3 works as “erasing discharge” for erasing unnecessary wall charge in the discharge cell having undergone the sustain discharge.

When the increasing voltage arrives at predetermined voltage Vers, the voltage applied to scan electrode SC 1 through scan electrode SCn is decreased to 0 (V) as base potential. Thus, the sustain operation in the sustain period is completed.

In the initializing period of the second SF, the driving voltage waveform where the first half of the initializing period of the first SF is omitted is applied to each electrode. Voltage Ve1 is applied to sustain electrode SU1 through sustain electrode SUn, and voltage 0 (V) is applied to data electrode D1 through data electrode Dm. Down-ramp voltage L4, which gently decreases from voltage Vi3′ (e.g. voltage 0 (V)) lower than the discharge start voltage to negative voltage Vi4 exceeding the discharge start voltage, is applied to scan electrode SC1 through scan electrode SCn. As one example of the gradient of down-ramp voltage L4, a numerical value of about −2.5 V/μsec can be used.

Thus, feeble initializing discharge occurs in the discharge cell having undergone the sustain discharge in the sustain period of the immediately preceding subfield (first SF in FIG. 3). Then, the wall voltages on scan electrode SCi and sustain electrode SUi are reduced, and the wall voltage on data electrode Dk is also adjusted to a value appropriate to the address operation. In the discharge cell having undergone no sustain discharge in the sustain period of the immediately preceding subfield, initializing discharge does not occur, and the wall charge at the completion of the initializing period of the immediately preceding subfield is kept as it is. Thus, the initializing operation in the second SF becomes the selective initializing operation of causing initializing discharge in the discharge cell that has undergone sustain discharge in the sustain period of the immediately preceding subfield.

In the address period and sustain period of the second SF, driving voltage waveforms similar to those in the address period and sustain period of the first SF are applied to each electrode except for the number of generated sustain pulses. In each of the third SF and later, a driving voltage waveform similar to that in the second SF is applied to each electrode except for the number of generated sustain pulses.

The driving voltage waveform applied to each electrode of panel 10 of the present exemplary embodiment has been described schematically.

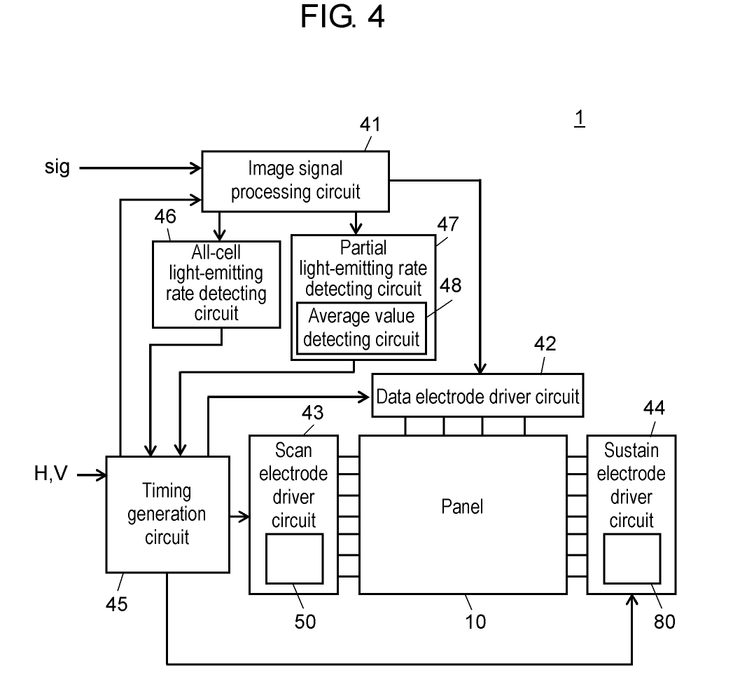

Next, the configuration of the plasma display apparatus of the present exemplary embodiment is described. FIG. 4 is a circuit block diagram of plasma display apparatus 1 in accordance with the first exemplary embodiment of the present invention. Plasma display apparatus 1 includes the following elements:
panel 10;
image signal processing circuit 41;
data electrode driver circuit 42;
scan electrode driver circuit 43;
sustain electrode driver circuit 44;
timing generation circuit 45;
all-cell light-emitting rate detecting circuit 46;
partial light-emitting rate detecting circuit 47; and
a power supply circuit (not shown) for supplying power required for each circuit block.

Image signal processing circuit 41 assigns a gradation value to each discharge cell based on input image signal sig. Then, image signal processing circuit 41 converts the gradation value into image data that indicates light emission or no light emission in each subfield.

For example, when input image signal sig includes an R signal, G signal, and B signal, image signal processing circuit 41 assigns each gradation value of R, G, and B to each discharge cell based on the R signal, G signal, and B signal. Alternatively, when input image signal sig includes a luminance signal (Y signal) and a chroma signal (C signal, R-Y signal and B-Y signal, or u signal and v signal), image signal processing circuit 41 calculates the R signal, G signal, and B signal based on the luminance signal and chroma signal, and then assigns each gradation value (gradation value represented in one field) of R, G, and B to each discharge cell. Image signal processing circuit 41 converts each gradation value of R, G, and B assigned to each discharge cell into image data that indicates light emission or no light emission in each subfield.

Based on the image data for each subfield, all-cell light-emitting rate detecting circuit 46 detects, as “all-cell light-emitting rate”, the ratio of the number of discharge cells to be lit to the total number of discharge cells in the image display surface of panel 10 in each subfield. All-cell light-emitting rate detecting circuit 46 outputs a signal indicating the detected all-cell light-emitting rate to timing generation circuit 45.

Partial light-emitting rate detecting circuit 47 divides the image display surface of panel 10 into a plurality of regions and detects, as “partial light-emitting rate”, the ratio of the number of discharge cells to be lit to the number of discharge cells in each region in each subfield based on the image data in each subfield. Partial light-emitting rate detecting circuit 47 may be configured to detect the partial light-emitting rate while the region constituted by a plurality of scan electrodes 22 that is connected to one of integrated circuits (ICs) (hereinafter referred to as “scan ICs”) for driving scan electrodes 22 is set as one region, for example. In the present exemplary embodiment, however, the partial light-emitting rate is detected while one display electrode pair 24 is considered as one region.

Partial light-emitting rate detecting circuit 47 includes average value detecting circuit 48. Average value detecting circuit 48 compares the partial light-emitting rate detected by partial light-emitting rate detecting circuit 47 with a predetermined threshold. Hereinafter, the predetermined threshold is referred to as “partial light-emitting rate threshold”. Then, average value detecting circuit 48 calculates, in each subfield, the average value of the partial light-emitting rates in display electrode pairs 24 other than display electrode pairs 24 where the partial light-emitting rate is the partial light-emitting rate threshold or lower, namely in display electrode pairs 24 where the partial light-emitting rate exceeds the partial light-emitting rate threshold. Then, average value detecting circuit 48 outputs a signal that indicates the result to timing generation circuit 45. For example, it is assumed that the number of display electrode pairs 24 disposed on panel 10 is 1080 and the partial light-emitting rates of 200 display electrode pairs 24 are the partial light-emitting rate threshold or lower in a certain subfield. In this case, in the certain subfield, average value detecting circuit 48 calculates the average value of the partial light-emitting rates of 880 display electrode pairs 24 where the partial light-emitting rate exceeds the partial light-emitting rate threshold.

In the present exemplary embodiment, the partial light-emitting rate threshold is set at “0%”. The purpose of this setting is to omit display electrode pairs 24 where a discharge cell to be lit does not substantially occur when an average value of the partial light-emitting rates is calculated.

However, the partial light-emitting rate threshold of the present invention is not limited to the above-mentioned numerical value. Preferably, the partial light-emitting rate threshold is set at the optimal value based on the characteristics of panel 10 and the specification of plasma display apparatus 1.

In the present exemplary embodiment, a normalizing operation for percentage notation (% notation) is performed when the all-cell light-emitting rate and partial light-emitting rates are calculated. However, the normalizing operation is not necessarily required. For example, the calculated number of discharge cells to be lit may be used instead of the all-cell light-emitting rate and partial light-emitting rates. Hereinafter, a discharge cell to be lit is referred to as “lit cell”, and a discharge cell that is not to be lit is referred to as “unlit cell”.

Timing generation circuit 45 generates various timing signals for controlling the operation of each circuit block based on horizontal synchronizing signal H, vertical synchronizing signal V, and outputs from all-cell light-emitting rate detecting circuit 46 and partial light-emitting rate detecting circuit 47. Then, timing generation circuit 45 supplies the generated timing signals to respective circuit blocks (image signal processing circuit 41, data electrode driver circuit 42, scan electrode driver circuit 43, and sustain electrode driver circuit 44).

In the present exemplary embodiment, as discussed above, the number of generated sustain pulses is altered in response to the all-cell light-emitting rate and the average value of the partial light-emitting rates. Specifically, the number of generated sustain pulses, which is set by timing generation circuit 45 based on the input image signal and the luminance weight set for each subfield, is altered by correcting the number of generated sustain pulses using a correction coefficient that is determined based on the all-cell light-emitting rate and the average value of the partial light-emitting rates. For this purpose, timing generation circuit 45 has a number-of-sustain-pulses correcting section (not shown) capable of correcting the number of generated sustain pulses based on the all-cell light-emitting rate and the average value of the partial light-emitting rates.

In the present exemplary embodiment, the number-of-sustain-pulses correcting section has a look-up table that can previously store a plurality of different correction coefficients in association with the all-cell light-emitting rate and the partial light-emitting rates, and can read one of the correction coefficients in response to the all-cell light-emitting rate and the average value of the partial light-emitting rates. The details of these configurations are described later. However, the present invention is not limited to these configurations. Any configuration may be employed as long as it performs the same operation.

Scan electrode driver circuit 43 has an initializing waveform generation circuit (not shown), sustain pulse generation circuit 50, and a scan pulse generation circuit (not shown). The initializing waveform generation circuit generates an initializing waveform to be applied to scan electrode SC1 through scan electrode SCn in the initializing period. Sustain pulse generation circuit 50 generates a sustain pulse to be applied to scan electrode SC1 through scan electrode SCn in the sustain period. The scan pulse generation circuit has a plurality of scan electrode driver ICs (scan ICs), and generates a scan pulse to be applied to scan electrode SC1 through scan electrode SCn in the address period. Scan electrode driver circuit 43 drives each of scan electrode SC1 through scan electrode SCn based on the timing signal supplied from timing generation circuit 45.

Data electrode driver circuit 42 converts the data, which constitutes image data, of each subfield into a signal corresponding to each of data electrode D1 through data electrode Dm. Data electrode driver circuit 42 drives each of data electrode D1 through data electrode Dm based on the converted signal and the timing signal supplied from timing generation circuit 45.

Sustain electrode driver circuit 44 has sustain pulse generation circuit 80 and a circuit (not shown) for generating voltage Ve1 and voltage Ve2. Sustain electrode driver circuit 44 drives sustain electrode SU1 through sustain electrode SUn based on the timing signal supplied from timing generation circuit 45.

Next, the details and operation of scan electrode driver circuit 43 are described. In the following description, an operation of turning on a switching element is denoted as “ON”, and an operation of turning off it is denoted as “OFF”. A signal for setting the switching element at ON is denoted as “Hi”, and a signal for setting it at OFF is denoted as “Lo”.

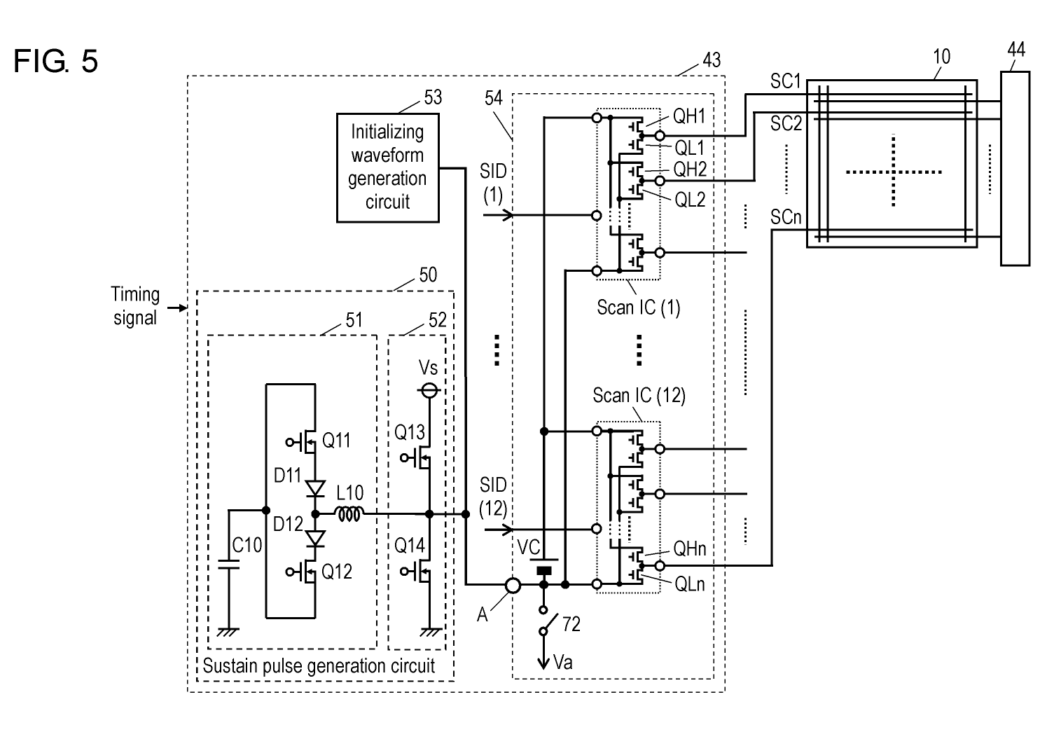

FIG. 5 is a circuit diagram showing the configuration of scan electrode driver circuit 43 of plasma display apparatus 1 in accordance with the first exemplary embodiment of the present invention. Scan electrode driver circuit 43 has sustain pulse generation circuit 50 on the side of scan electrodes 22, initializing waveform generation circuit 53, and scan pulse generation circuit 54. Each output terminal of scan pulse generation circuit 54 is connected to each of scan electrode SC1 through scan electrode SCn of panel 10. The purpose of this connection is to individually apply a scan pulse to each of scan electrodes 22 in the address period.

Initializing waveform generation circuit 53 generates initializing waveforms of FIG. 3 that increase or decrease reference potential A of scan pulse generation circuit 54 in a ramp shape in the initializing period. Reference potential A means the voltage to be input to scan pulse generation circuit 54 as shown in FIG. 5.

Sustain pulse generation circuit 50 includes power recovery circuit 51 and clamping circuit 52.

Power recovery circuit 51 includes capacitor C10 for power recovery, switching element Q11, switching element Q12, diode D11 for back flow prevention, diode D12 for back flow prevention, and inductor L10 for resonance. Power recovery circuit 51 raises and drops a sustain pulse by LC-resonance between inter-electrode capacity Cp and inductor L10.

Clamping circuit 52 has switching element Q13 for clamping scan electrode SC1 through scan electrode SCn on voltage Vs, and switching element Q14 for clamping scan electrode SC1 through scan electrode SCn on 0 (V) as base potential. Clamping circuit 52 connects scan electrode SC1 through scan electrode SCn to power supply VS via switching element Q13, thereby clamping them on voltage Vs. Clamping circuit 52 connects scan electrode SC1 through scan electrode SCn to the ground potential to clamp them on 0 (V) via switching element Q14. Sustain pulse generation circuit 50 generates a sustain pulse by operating power recovery circuit 51 and clamping circuit 52 by switching each of switching element Q11, switching element Q12, switching element Q13, and switching element Q14 between turn on and turn off in response to the timing signal output from timing generation circuit 45.

For example, for raising a sustain pulse, switching element Q11 is set at ON to cause resonance between inter-electrode capacity Cp and inductor L10, and supplies electric power from capacitor C10 for power recovery to scan electrode SC1 through scan electrode SCn via switching element Q11, diode D11, and inductor L10. When the voltage of scan electrode SC1 through scan electrode SCn approaches voltage Vs, switching element Q13 is set at ON. Thus, a circuit for driving scan electrode SC1 through scan electrode SCn is switched from power recovery circuit 51 to clamping circuit 52, and scan electrode SC1 through scan electrode SCn are clamped on voltage Vs.

Conversely, for dropping a sustain pulse, switching element Q12 is set at ON to cause resonance between inter-electrode capacity Cp and inductor L10, and recovers electric power from inter-electrode capacity Cp to capacitor C10 for power recovery via inductor L10, diode D12, and switching element Q12.

When the voltage of scan electrode SC1 through scan electrode SCn approaches 0 (V), switching element Q14 is set at ON. Thus, a circuit for driving scan electrode SC1 through scan electrode SCn is switched from power recovery circuit 51 to clamping circuit 52, and scan electrode SC1 through scan electrode SCn are clamped on 0 (V) as base potential.

These switching elements can be formed using a generally known element such as a metal oxide semiconductor field effect transistor (MOSFET) or an insulated gate bipolar transistor (IGBT).

Sustain pulse generation circuit 54 includes the following elements:
switch 72 for connecting reference potential A to negative voltage Va in the address period;
power supply VC for generating voltage Vc; and
switching element QH1 through switching element QHn and switching element QL1 through switching element QLn for applying a scan pulse to each of n scan electrode SC1 through scan electrode SCn.
   Switching element QH1 through switching element QHn and switching element QL1 through switching element QLn are classified into groups each of which has a plurality of outputs to provide integrated circuits (ICs). These ICs are scan ICs. When switching element QH1 is set at OFF and switching element QL1 is set at ON, a scan pulse of negative voltage Va is applied to scan electrode SCi via switching element QL1.

When initializing waveform generation circuit 53 or sustain pulse generation circuit 50 is being operated, by setting switching element QH1 through switching element QHn at OFF and setting switching element QL1 through switching element QLn at ON, an initializing waveform or sustain pulse is applied to each of scan electrode SC1 through scan electrode SCn via switching element QL1 through switching element QLn.

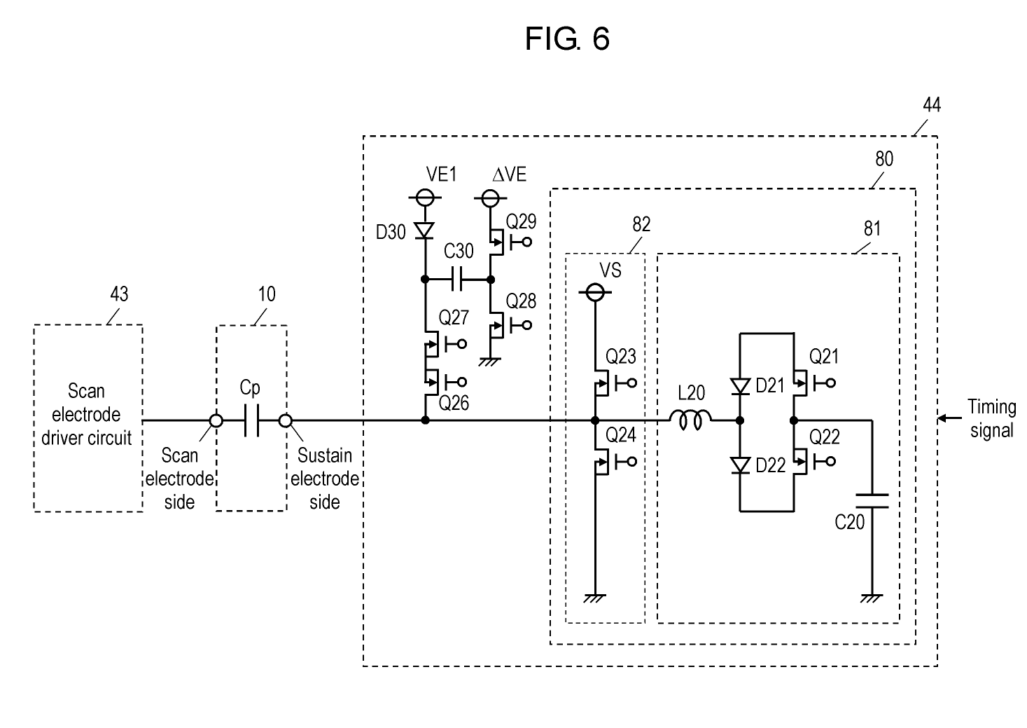

FIG. 6 is a circuit diagram showing the configuration of sustain electrode driver circuit 44 of plasma display apparatus 1 in accordance with the first exemplary embodiment of the present invention. In FIG. 6, the inter-electrode capacity of panel 10 is denoted as Cp, and the circuit diagram of scan electrode driver circuit 43 is omitted.

Sustain electrode driver circuit 44 has sustain pulse generation circuit 80 having a configuration similar to that of sustain pulse generation circuit 50. Sustain pulse generation circuit 80 includes power recovery circuit 81 and clamping circuit 82, and is connected to sustain electrode SU1 through sustain electrode SUn of panel 10. Thus, the output voltage of sustain electrode driver circuit 44 is applied to all of sustain electrodes 23 in parallel, and sustain electrode driver circuit 44 drives all of sustain electrodes 23 collectively. This is because, in either of the address period and sustain period, individual driving of sustain electrodes 23 is not required differently from scan electrodes 22 and driving voltage is applied to all of sustain electrodes 23 collectively.

Power recovery circuit 81 includes capacitor C20 for power recovery, switching element Q21, switching element Q22, diode D21 for back flow prevention, diode D22 for back flow prevention, and inductor L20 for resonance. Clamping circuit 82 has switching element Q23 for clamping sustain electrode SU1 through sustain electrode SUn on voltage Vs, and switching element Q24 for clamping sustain electrode SU1 through sustain electrode SUn on ground potential (0 (V)).

Sustain pulse generation circuit 80 generates a sustain pulse while switching each switching element between ON and OFF based on the timing signal output from timing generation circuit 45. The operation of sustain pulse generation circuit 80 is similar to that of sustain pulse generation circuit 50, and hence is not described.

Sustain electrode driver circuit 44 includes the following elements:
power supply VE1 for generating voltage Ve1;
switching element Q26 for applying voltage Ve1 to sustain electrodes SU1 through sustain electrode SUn;
switching element Q27;
power supply ΔVE for generating voltage ΔVe;
diode D30 for back flow prevention;
capacitor C30 for a charge pump for adding voltage ΔVe to voltage Ve1;
switching element Q28 for adding voltage ΔVe to voltage Ve1 to generate voltage Ve2; and
switching element Q29.

Next, the difference in emission luminance caused by variation in driving load is described.

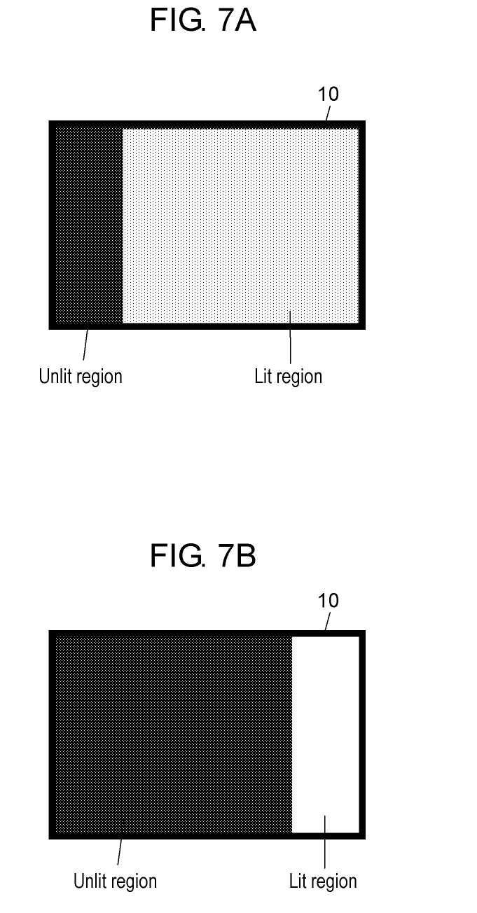

FIG. 7A and FIG. 7B are schematic diagrams for describing the difference in emission luminance caused by variation in driving load. FIG. 7A and FIG. 7B schematically show the light emission state of the image display surface of panel 10 in a certain subfield. In these diagrams, each black region shows a region (unlit region) where light is not emitted in the discharge cells, and each white region shows a region (lit region) where light is emitted in the discharge cells. FIG. 7A is a diagram for schematically showing the light emission state of panel 10 when the lit region is set as 80% of the image display surface. FIG. 7B is a diagram for schematically showing the light emission state of panel 10 when the lit region is set as 20% of the image display surface. In FIG. 7A and FIG. 7B, it is assumed that display electrode pairs 24 are extended in the row direction (parallel with the long side of panel 10, namely horizontal direction in the diagrams) similarly to panel 10 of FIG. 2.

When light is emitted on panel 10 while the area of the lit region is altered as shown in FIG. 7A and FIG. 7B, emission luminance in the lit region varies. The reason for this is considered as below.

Display electrode pairs 24 are extended in the row direction as discussed above. Therefore, when light is emitted on panel 10 while the lit region is altered as shown in FIG. 7A and FIG. 7B, the number of lit cells occurring on display electrode pairs 24 varies. As the lit region becomes narrow, the number of lit cells occurring on display electrode pairs 24 decreases. Therefore, the driving load is smaller in display electrode pairs 24 having the light emission state shown in FIG. 7B (the area of the lit region is small) than in display electrode pairs 24 having the light emission state shown in FIG. 7A (the area of the lit region is large). Therefore, voltage drop of the driving voltage (for example, sustain pulse) is smaller in display electrode pairs 24 having the light emission state shown in FIG. 7B than in display electrode pairs 24 having the light emission state shown in FIG. 7A. In other words, the discharge intensity of the sustain discharge in the lit region shown in FIG. 7B is stronger than that of the sustain discharge in the lit region shown in FIG. 7A. As a result, the emission luminance is higher in the lit region shown in FIG. 7B than in the lit region shown in FIG. 7A.

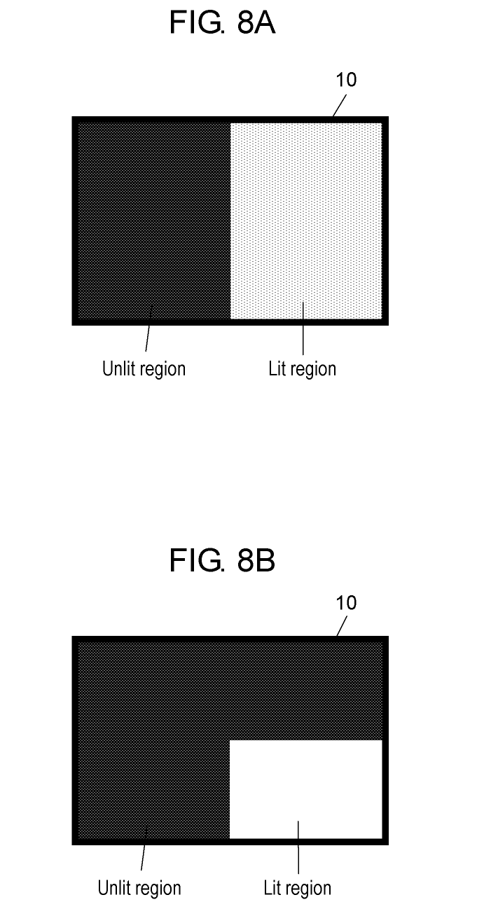

FIG. 8A and FIG. 8B are schematic diagrams for describing another example of the difference in emission luminance caused by variation in driving load. FIG. 8A and FIG. 8B schematically show the light emission state of the image display surface of panel 10 in a certain subfield. FIG. 8A is a diagram for schematically showing the light emission state of panel 10 when the lit region is set as 50% of the image display surface. FIG. 8B is a diagram for schematically showing the light emission state of panel 10 when the lit region is set as 25% of the image display surface.

FIG. 7A and FIG. 7B show an example where the partial light-emitting rate varies and the driving load of display electrode pairs 24 in the lit region varies. As shown in FIG. 8A and FIG. 8B, however, even when the partial light-emitting rate in the lit region does not vary, the emission luminance in the lit region varies when the total number of lit cells, namely the all-cell light-emitting rate, varies. This is mainly considered to be because, since sustain electrode driver circuit 44 is connected to all sustain electrodes 23 in parallel and all sustain electrodes 23 are driven collectively by sustain electrode driver circuit 44 as discussed above, the voltage drop of the output voltage from sustain electrode driver circuit 44 is varied by variation in all-cell light-emitting rate.

In other words, in order to accurately estimate the variation in emission luminance in lit cells, preferably, both the all-cell light-emitting rate and the partial light-emitting rates on panel 10 are detected.

Thus, in the present exemplary embodiment, the all-cell light-emitting rate and the partial light-emitting rates are detected for each subfield. In the present exemplary embodiment, the average value of the partial light-emitting rates is detected. In other words, in the present exemplary embodiment, the all-cell light-emitting rate and the average value of the partial light-emitting rates are detected for each subfield.

The number of generated sustain pulses in the sustain period of the subfield having undergone the detection is altered based on the detection result, and the luminance generated in the sustain period is controlled. This luminance means the luminance obtained by accumulating the emitted light generated by sustain discharge in the sustain period. The luminance in each subfield is thus kept at a predetermined brightness. Thus, the linearity of the gradation in the display image is kept, and the image display quality can be improved.

In the present exemplary embodiment, the number of generated sustain pulses set based on the input image signal and luminance weight is corrected using a correction coefficient that is set based on the all-cell light-emitting rate and the average value of the partial light-emitting rates. In the sustain period, as many sustain pulses as the number after the correction are generated. Thus, the number of generated sustain pulses is controlled.

Next, one example of a setting method of the correction coefficient is described.

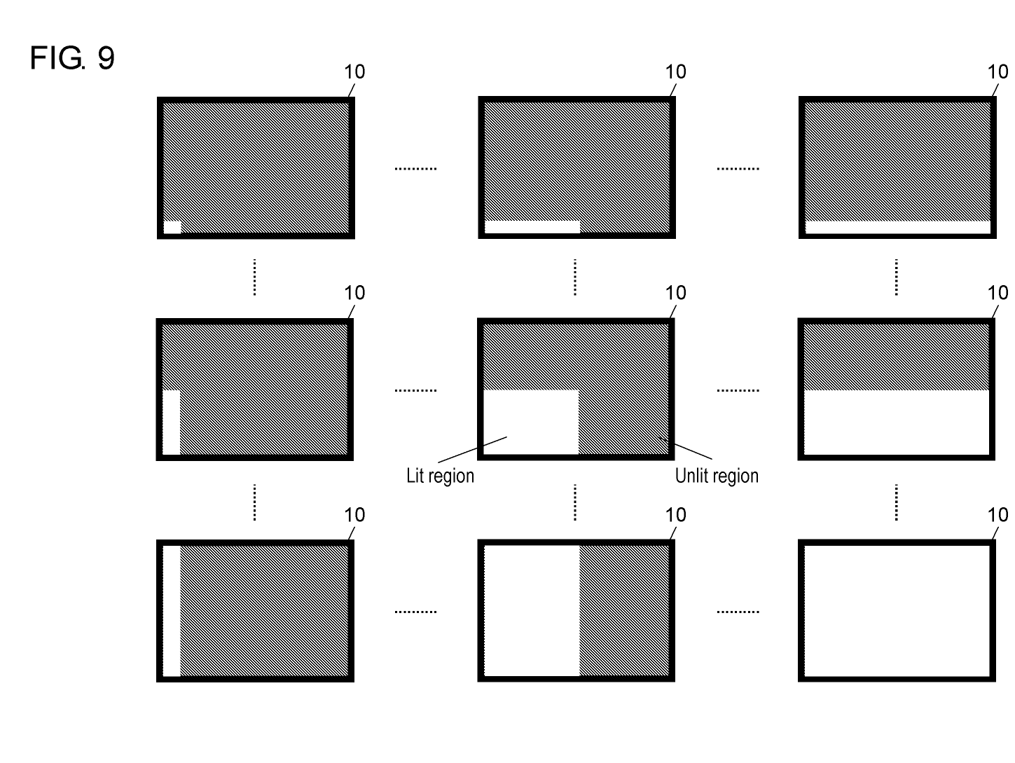

FIG. 9 is a diagram for schematically showing the measurement of emission luminance performed for setting the correction coefficient in accordance with the first exemplary embodiment of the present invention. In the present exemplary embodiment, in order to set the correction coefficient, an image that is partitioned into two regions, namely a lit region and an unlit region, is displayed on panel 10. Then, the area of the lit region is gradually altered while the emission luminance in the lit region is measured, as shown in FIG. 9.

For example, an image is displayed where the length of the row direction (horizontal direction in FIG. 9) and the length of the column direction (parallel with the short side of panel 10, namely vertical direction in FIG. 9) of the lit region are set as 10% of those of the image display surface of panel 10, and the emission luminance of the lit region is measured. Thus, the emission luminance of the image where the all-cell light-emitting rate is 1% and the average value of the partial light-emitting rates is 10% can be acquired.

Next, an image is displayed where the length of the row direction of the lit region is 10% of that of the image display surface of panel 10 and the length of the column direction of the lit region is 20% of that of the image display surface, and the emission luminance of the lit region is measured. Thus, the emission luminance of the image where the all-cell light-emitting rate is 2% and the average value of the partial light-emitting rates is 10% can be acquired.

Similarly, the emission luminance is measured while the lit region is gradually enlarged. By repeating the measurement, respective emission luminances of a plurality of images having different all-cell light-emitting rate and different average value of partial light-emitting rates can be acquired.

Then, a reference emission luminance is set at “1”, and each emission luminance is normalized. For example, the emission luminance of the image where the all-cell light-emitting rate and the average value of the partial light-emitting rates are 100% is assumed to be the reference emission luminance, and each emission luminance is normalized. The inverse of each numerical value is then calculated. In the present exemplary embodiment, the calculation result is set as the correction coefficient. For example, it is assumed that the emission luminance of the image where the all-cell light-emitting rate and the average value of the partial light-emitting rates are 100% is set at “1”. When the emission luminance of an image where the all-cell light-emitting rate is 5% and the average value of the partial light-emitting rates is 40% is “1.25”, the inverse of “1.25”, namely “0.80”, is set as the correction coefficient when the all-cell light-emitting rate is 5% and the average value of partial light-emitting rates is 40%.

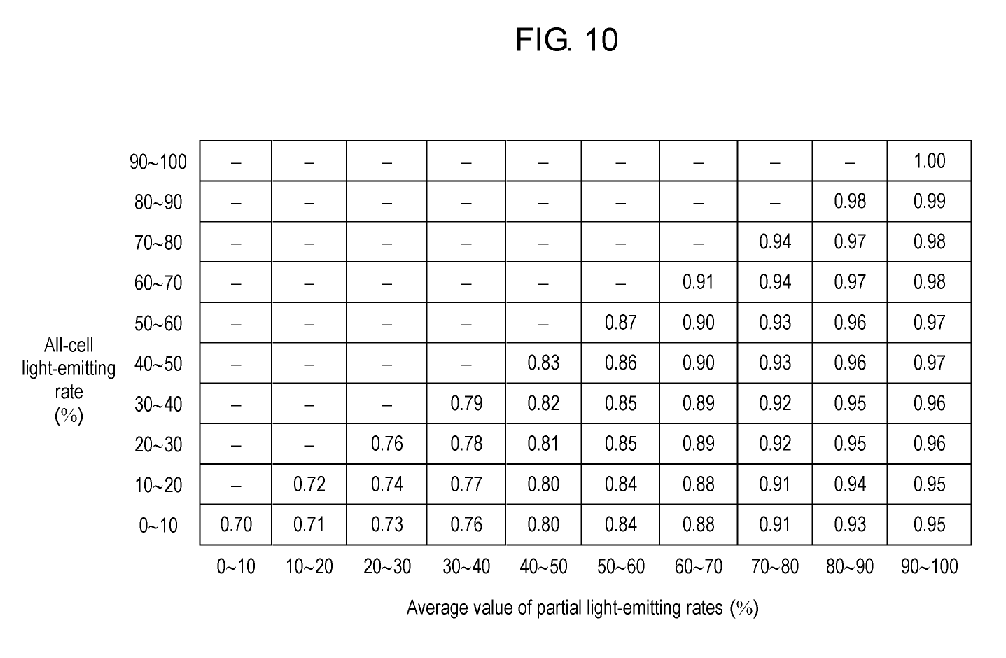

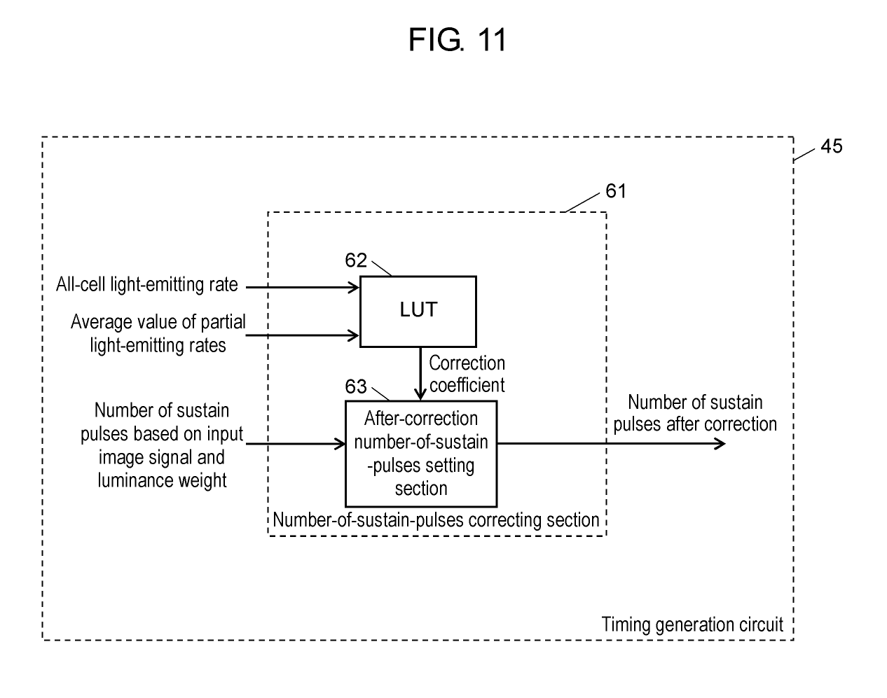

FIG. 10 is a diagram showing one example of the correction coefficients in accordance with the first exemplary embodiment of the present invention. FIG. 11 is a circuit block diagram of number-of-sustain-pulses correcting section 61 in accordance with the first exemplary embodiment of the present invention.

As shown in FIG. 11, timing generation circuit 45 of the present exemplary embodiment includes number-of-sustain-pulses correcting section 61.

Number-of-sustain-pulses correcting section 61 has look-up table 62 (“LUT” in FIG. 11) and after-correction number-of-sustain-pulses setting section 63. Look-up table 62 previously stores a plurality of correction coefficients and allows reading of one correction coefficient based on the all-cell light-emitting rate and the average value of the partial light-emitting rates. After-correction number-of-sustain-pulses setting section 63 multiplies the correction coefficient read from look-up table 62 by the number (hereinafter, simply referred to as “number of sustain pulses”) of generated sustain pulses set based on the input image signal and luminance weight, and outputs the multiplication result. This multiplication result is the number of sustain pulses after the correction (number of sustain pulses after correction).

Then, timing generation circuit 45 generates a timing signal for controlling each circuit block so that as many sustain pulses as the number of sustain pulses after correction output from after-correction number-of-sustain-pulses setting section 63 are output from sustain pulse generation circuit 50 and sustain pulse generation circuit 80.

In FIG. 10, the all-cell light-emitting rate (the range of 0% to 100%) is divided into 10 stages by 10%, the average value (the range of 0% to 100%) of the partial light-emitting rates is divided into 10 stages by 10% for each stage of the all-cell light-emitting rate, and a correction coefficient corresponding to each stage of the all-cell light-emitting rate and each stage of the average value of partial light-emitting rates is shown. When the all-cell light-emitting rate is 100% for example, the average value of the partial light-emitting rates is not lower than 100%. Combinations that do not substantially occur are denoted as “-” in FIG. 10. FIG. 10 shows simply one example. The dividing manner of the all-cell light-emitting rate and the average value of partial light-emitting rates of the present invention is not limited to the dividing manner shown in FIG. 10. Each correction coefficient is not limited to the numerical value of FIG. 10, either.

In the present exemplary embodiment, as shown in FIG. 10, the correction coefficients acquired by the above-mentioned method are expressed by a matrix in association with the all-cell light-emitting rate and the average value of the partial light-emitting rates. The matrix is stored on look-up table 62. From the plurality of correction coefficients stored on look-up table 62, one correction coefficient is read based on the all-cell light-emitting rate and the average value of the partial light-emitting rates detected for each subfield. Then, the number of generated sustain pulses in the subfield is corrected using the read correction coefficient.

For example, it is assumed that the number of generated sustain pulses set based on the input image signal and luminance weight in the sixth SF is “128”. It is also assumed that the all-cell light-emitting rate in the sixth SF is 5% and the average value of the partial light-emitting rates is 45%. In this case, the correction coefficient acquired from the data of look-up table 62 of FIG. 10 is “0.80”. Therefore, after-correction number-of-sustain-pulses setting section 63 multiplies “128” by “0.80”. The multiplication result is “102”, so that the number of generated sustain pulses in the sixth SF is set at “102”. Thus, the luminance of the sixth SF can be set at 80% of that when the number of generated sustain pulses is set at “128”. Therefore, the luminance of the sixth SF can be made equivalent to that when the all-cell light-emitting rate in the sixth SF is 100%.

In the present exemplary embodiment, thus, the luminance of each subfield can be always equal to a predetermined luminance regardless of the lit state of the discharge cell, by correcting the number of generated sustain pulses set based on the input image signal and luminance weight by using a correction coefficient that is determined based on the all-cell light-emitting rate and the average value of the partial light-emitting rates in each subfield. For example, the predetermined luminance is the luminance when the all-cell light-emitting rate is 100%.

As discussed above, in the present exemplary embodiment, the all-cell light-emitting rate and the average value of the partial light-emitting rates are detected in each subfield. One correction coefficient is read from look-up table 62 based on the all-cell light-emitting rate and the average value of the partial light-emitting rates that are detected for each subfield. Here, look-up table 62 previously stores a plurality of preset correction coefficients in association with the all-cell light-emitting rate and the average value of the partial light-emitting rates. Then, after-correction number-of-sustain-pulses setting section 63 corrects the number of generated sustain pulses set based on the input image signal and luminance weight by using the correction coefficient. Thanks to such a configuration, the variation in emission luminance occurring in each subfield can be estimated accurately, and the luminance of each subfield can be always kept at a predetermined luminance (for example, the luminance when the all-cell light-emitting rate is 100%) based on the estimation result. Therefore, the linearity of gradation in the display image can be kept and the image display quality can be enhanced.

In the present exemplary embodiment, the configuration has been described where each correction coefficient is set while the maximum value of the correction coefficients is assumed to be “1”. In this case, the number of sustain pulses after correction is equal to or smaller than the number of sustain pulses before correction. This configuration is simply one example that is effective when the total period required for each subfield arrives at about one-field period and it is therefore difficult to increase the number of sustain pulses by extending the sustain period. The present invention is not limited to this configuration. In a case where the total period required for each subfield is shorter than one-field period and the number of sustain pulses can be increased by extending the sustain period, for example a case where the luminance magnification is small, plasma display apparatus 1 may have the following configuration:
each correction coefficient is set so that the maximum value of the correction coefficients is larger than “1”; and
a subfield is generated where the number of generated sustain pulses is increased by correction.
   In any configuration, preferably, each correction coefficient is set so that the total period required for each subfield after the correction does not exceed one-field period.

### Second Exemplary Embodiment

In the first exemplary embodiment, the configuration has been described where each correction coefficient is set so that the maximum value of the correction coefficients is “1”. In this case, the number of sustain pulses after correction is equal to or smaller than the number of sustain pulses before correction. When the number of sustain pulses after correction is smaller than that before correction, the luminance of a display image decreases. In the second exemplary embodiment, the configuration is described where, after the correction of the first exemplary embodiment, new correction is performed where the total number of sustain pulses generated in one field period is equivalent to that before the former correction. In the present exemplary embodiment, in order to differentiate between these corrections, the correction of the first exemplary embodiment is called “first correction” and the correction coefficient used for “first correction” is called “first correction coefficient”. The new correction of the present exemplary embodiment is called “second correction” and the correction coefficient used for “second correction” is called “second correction coefficient”. “First correction coefficient” is set for each subfield, and “second correction coefficient” is commonly set for all subfields in one field.

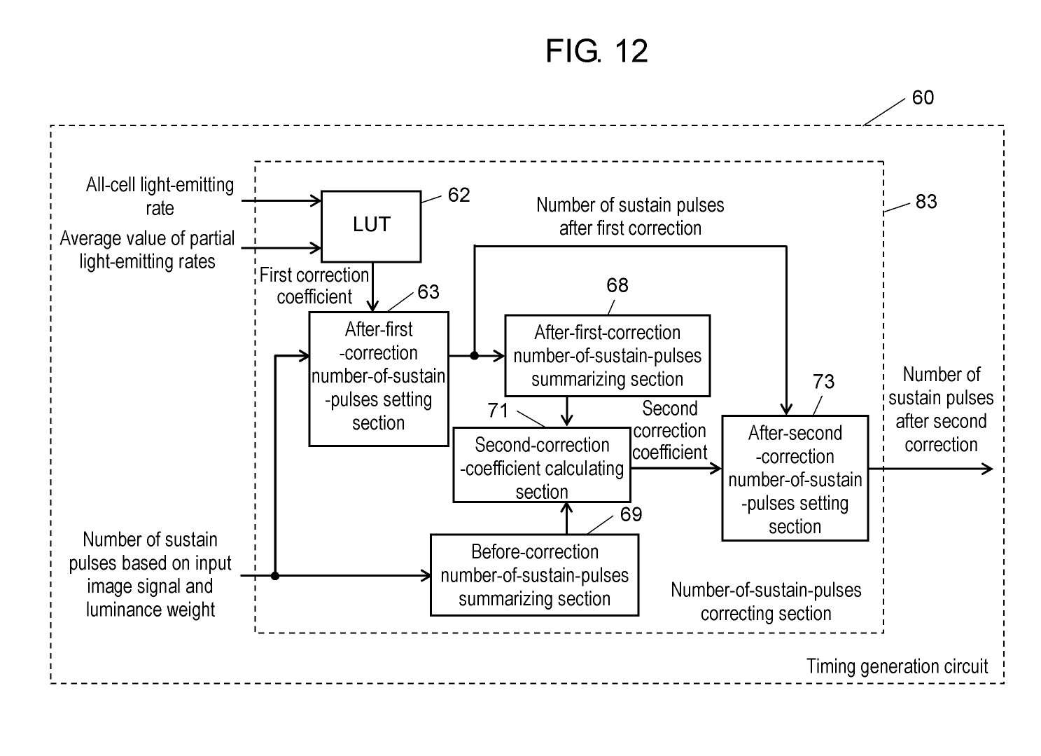

FIG. 12 is a diagram showing a part of circuit blocks of timing generation circuit 60 in accordance with the second exemplary embodiment of the present invention. FIG. 12 shows only circuit blocks related to “first correction” and “second correction”, and the other circuit blocks are omitted.

In FIG. 12, timing generation circuit 60 of the present exemplary embodiment includes number-of-sustain-pulses correcting section 83. Number-of-sustain-pulses correcting section 83 has look-up table 62 (“LUT” in FIG. 12), after-first-correction number-of-sustain-pulses setting section 63, after-first-correction number-of-sustain-pulses summarizing section 68, before-correction number-of-sustain-pulses summarizing section 69, second-correction-coefficient calculating section 71, and after-second-correction number-of-sustain-pulses setting section 73. The configurations and operations of look-up table 62 and after-first-correction number-of-sustain-pulses setting section 63 shown in FIG. 12 are similar to those of look-up table 62 and after-correction number-of-sustain-pulses setting section 63 shown in FIG. 11, and hence are not described.

After-first-correction number-of-sustain-pulses summarizing section 68 accumulates the numbers of sustain pulses after “first correction” in respective subfields output from after-first-correction number-of-sustain-pulses setting section 63 for one field period. Thus, when “first correction” is performed, the total number of sustain pulses generated in one field period is calculated.

Before-correction number-of-sustain-pulses summarizing section 69 accumulates the numbers of sustain pulses in respective subfields set based on the input image signal and luminance weight for one field period. Thus, when “first correction” is not performed (hereinafter referred to as “before “first correction””), the total number of sustain pulses generated in one field period is calculated.

Second-correction-coefficient calculating section 71 divides the numerical value output from before-correction number-of-sustain-pulses summarizing section 69 by the numerical value output from after-first-correction number-of-sustain-pulses summarizing section 68. In other words, the total number of sustain pulses generated in one field period when “first correction” is not performed is divided by the total number of sustain pulses generated in one field period when “first correction” is performed. This operation result is “second correction coefficient” in the present exemplary embodiment.

After-second-correction number-of-sustain-pulses setting section 73 multiplies the numerical value output from after-first-correction number-of-sustain-pulses setting section 63 by “second correction coefficient” output from second-correction-coefficient calculating section 71. In other words, the number of sustain pulses after “first correction” in each subfield is multiplied by “_{second} correction coefficient” output from second-correction-coefficient calculating section 71. This multiplication result is “number of sustain pulses after second correction”. After-second-correction number-of-sustain-pulses setting section 73 outputs the number of sustain pulses after second correction.

Timing generation circuit 60 generates a timing signal for controlling each circuit block so that, in each subfield, as many sustain pulses as the number of sustain pulses after second correction output from after-second-correction number-of-sustain-pulses setting section 73 are output from sustain pulse generation circuit 50 and sustain pulse generation circuit 80.

Next, “second correction” of the present exemplary embodiment is described using a specific numerical value.

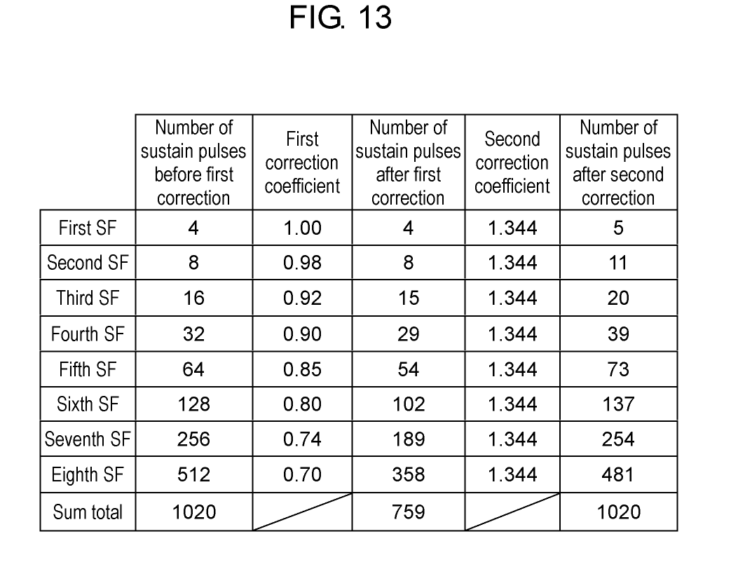

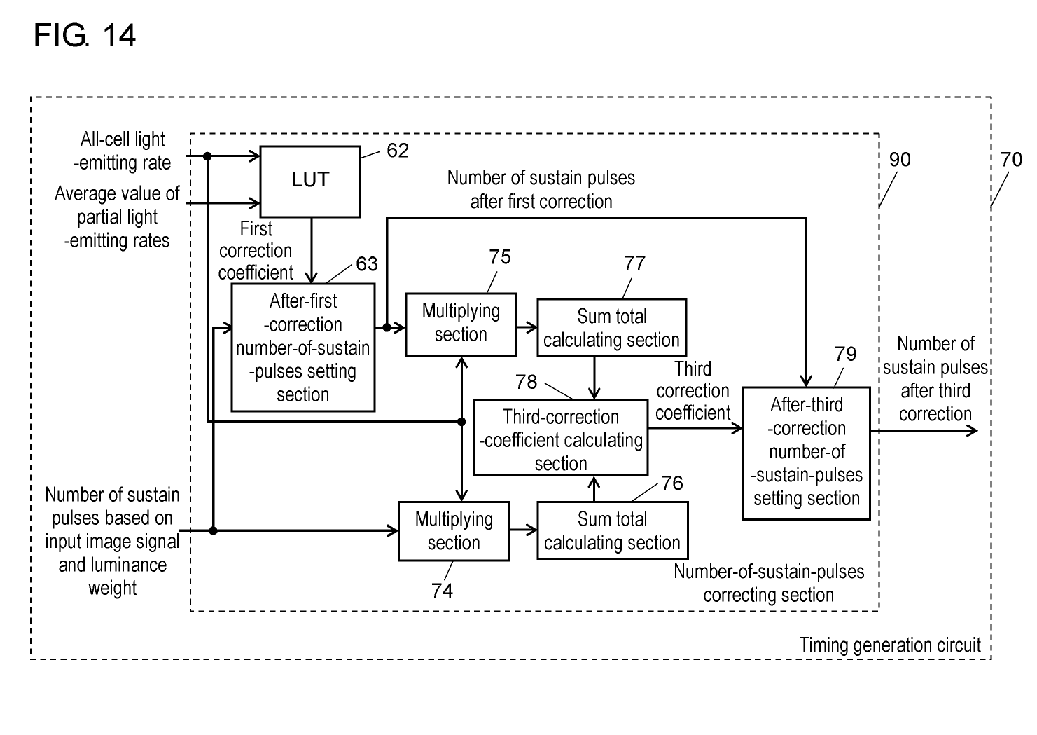

FIG. 13 is a diagram for illustrating “second correction” using a specific numerical value in accordance with the second exemplary embodiment of the present invention. FIG. 13 shows, for each subfield, the number of sustain pulses before “first correction”, “first correction coefficient”, the number of sustain pulses after “first correction”, “second correction coefficient”, and the number of sustain pulses after “second correction”.

For example, when the number of sustain pulses generated based on the input image signal and luminance weight is (4, 8, 16, 32, 64, 128, 256, and 512) in the first SF through eighth SF, respectively, the total number of sustain pulses in one field period calculated by before-correction number-of-sustain-pulses summarizing section 69 is “1020”.

It is assumed that “first correction coefficient” read from look-up table 62 based on the all-cell light-emitting rate and the average value of the partial light-emitting rates is (1.00, 0.98, 0.92, 0.90, 0.85, 0.80, 0.74, and 0.70) in the first SF through eighth SF, respectively. In this case, the number of sustain pulses after “first correction” calculated by after-first-correction number-of-sustain-pulses setting section 63 is (4, 8, 15, 29, 54, 102, 189, and 358) (the fractional portion is rounded) in the first SF through eighth SF, respectively.

Therefore, the total number of these numerical values, namely the numerical value output from after-first-correction number-of-sustain-pulses summarizing section 68, is “759”. According to these results, the number of sustain pulses generated in one field period after “first correction” is “759”, which is “261” smaller than the number (“1020”) of sustain pulses generated in one field period before “first correction”.

Next, second-correction-coefficient calculating section 71 divides “1020” calculated by before-correction number-of-sustain-pulses summarizing section 69 by “759” calculated by after-first-correction number-of-sustain-pulses summarizing section 68, and obtains “second correction coefficient”=“1.344”.

Then, after-second-correction number-of-sustain-pulses setting section 73 multiplies “1.344” obtained as “second correction coefficient” by the numbers (4, 8, 15, 29, 54, 102, 189, and 358) of sustain pulses in the first SF through eighth SF calculated by after-first-correction number-of-sustain-pulses setting section 63.

Thus, the number of sustain pulses generated after “second correction” is (5, 11, 20, 39, 73, 137, 254, and 481) (the fractional portion is rounded) in the first SF through eighth SF, respectively. The total number of these numerical values is “1020”. Therefore, thanks to “second correction”, the number of sustain pulses generated in one field period can be made equal to the total number “1020” of sustain pulses before “first correction”.

As discussed above, in the present exemplary embodiment, “second correction” capable of making the total number of sustain pulses in one field period equivalent to that before “first correction” is performed, in addition to “first correction” of the first exemplary embodiment. Thanks to such a configuration, the linearity of gradation in the display image can be kept, the reduction in brightness of the display image can be prevented, and hence the image display quality can be improved.

In the configuration of the present exemplary embodiment, the total number of sustain pulses in one field period after “second correction” can be made equivalent to that before “first correction”. Therefore, even when the total period required for each subfield arrives at about one-field period and increase of the number of sustain pulses by extension of the sustain period is difficult, the maximum value of the correction coefficients stored on look-up table 62 by “first correction” can be made larger than “1”. Therefore, the degree of freedom of the setting range of the correction coefficient can be increased.

### Third Exemplary Embodiment

In the second exemplary embodiment, the configuration has been described where “second correction” for making the total number of sustain pulses generated in one field period equivalent to that before “first correction” is performed. In this configuration, however, the power consumption after “second correction” can be larger than that before “first correction”. In the third exemplary embodiment, the configuration is described where, after “first correction” of the first exemplary embodiment, another new correction is performed where the estimated value of the power consumption in one field period is equivalent to that when “first correction” is not performed. In the present exemplary embodiment, in order to differentiate between these corrections, the new correction of the third exemplary embodiment is called “third correction” and the correction coefficient used for “third correction” is called “third correction coefficient”. “Third correction coefficient” is commonly set for all subfields in one field.

FIG. 14 is a diagram showing a part of circuit blocks of timing generation circuit 70 in accordance with the third exemplary embodiment of the present invention. FIG. 14 shows only circuit blocks related to “first correction” and “third correction”, and the other circuit blocks are omitted.

In FIG. 14, timing generation circuit 70 of the present exemplary embodiment includes number-of-sustain-pulses correcting section 90. Number-of-sustain-pulses correcting section 90 has look-up table 62 (“LUT” in FIG. 14), after-first-correction number-of-sustain-pulses setting section 63, multiplying section 74, multiplying section 75, sum total calculating section 76, sum total calculating section 77, third-correction-coefficient calculating section 78, and after-third-correction number-of-sustain-pulses setting section 79. The configurations and operations of look-up table 62 and after-first-correction number-of-sustain-pulses setting section 63 shown in FIG. 14 are similar to those of look-up table 62 and after-correction number-of-sustain-pulses setting section 63 shown in FIG. 11, and hence are not described.

Multiplying section 74 multiplies the number of sustain pulses set for each subfield based on the input image signal and the luminance weight by the all-cell light-emitting rate of the subfield. Thus, the estimated value of the power consumption in each sustain period when an image is displayed without “first correction” is calculated.

Sum total calculating section 76 calculates the sum total in one field period of the multiplication results output from multiplying section 74. Thus, sum total calculating section 76 calculates the sum total in one field period of the estimated values of the power consumption in respective sustain periods when an image is displayed without “first correction”.

Multiplying section 75 multiplies the number of sustain pulses after “first correction” of each subfield output from after-first-correction number-of-sustain-pulses setting section 63 by the all-cell light-emitting rate of the subfield. Thus, the estimated value of the power consumption in each sustain period when an image is displayed only through “first correction” is calculated.

Sum total calculating section 77 calculates the sum total in one field period of the multiplication results output from multiplying section 75. Thus, sum total calculating section 77 calculates the sum total in one field period of the estimated values of the power consumption in respective sustain periods when an image is displayed only through “first correction”.

The numerical values calculated by sum total calculating section 76 and sum total calculating section 77 indicate the estimated values of the power consumption in the sustain period, but do not indicate the power consumption in a strict sense. These estimated values are just approximate values that are determined by using the following phenomenon:
the power consumption in the sustain period is larger when the number of generated sustain pulses is large than when the number of generated sustain pulses is small; and
the power consumption in the sustain period is larger when the all-cell light-emitting rate is high than when the all-cell light-emitting rate is low.
   The present invention is not limited to this configuration. Another calculating method of the power consumption or another calculating method of the estimated value of the power consumption may be employed. For example, even when the all-cell light-emitting rate is 0% and sustain discharge does not occur on the image display surface, power consumption called reactive power that does not contribute on the light emission is generated by applying sustain pulses to scan electrodes 22 and sustain electrodes 23. Then, an offset value considering the reactive power is added to the all-cell light-emitting rate, and the result obtained by multiplying the addition result by the number of sustain pulses is accumulated for one field period, thereby calculating an estimated value closer to the actual power consumption.

Third-correction-coefficient calculating section 78 divides the numerical value output from sum total calculating section 76 by the numerical value output from sum total calculating section 77. In other words, third-correction-coefficient calculating section 78 divides the estimated value of the power consumption when an image is displayed without “first correction” by that when an image is displayed only through “first correction”. This operation result is “third correction coefficient” of the present exemplary embodiment.

After-third-correction number-of-sustain-pulses setting section 79 multiplies the numerical value output from after-first-correction number-of-sustain-pulses setting section 63 by “third correction coefficient” output from third-correction-coefficient calculating section 78. In other words, the number of sustain pulses after “first correction” in each subfield is multiplied by “third correction coefficient” output from third-correction-coefficient calculating section 78. This multiplication result is “number of sustain pulses after third correction”. After-third-correction number-of-sustain-pulses setting section 79 outputs the number of sustain pulses after third correction.

Timing generation circuit 70 generates a timing signal for controlling each circuit block so that, in each subfield, as many sustain pulses as the number of sustain pulses after third correction output from after-third-correction number-of-sustain-pulses setting section 79 are output from sustain pulse generation circuit 50 and sustain pulse generation circuit 80.

Next, “third correction” of the present exemplary embodiment is described using a specific numerical value.

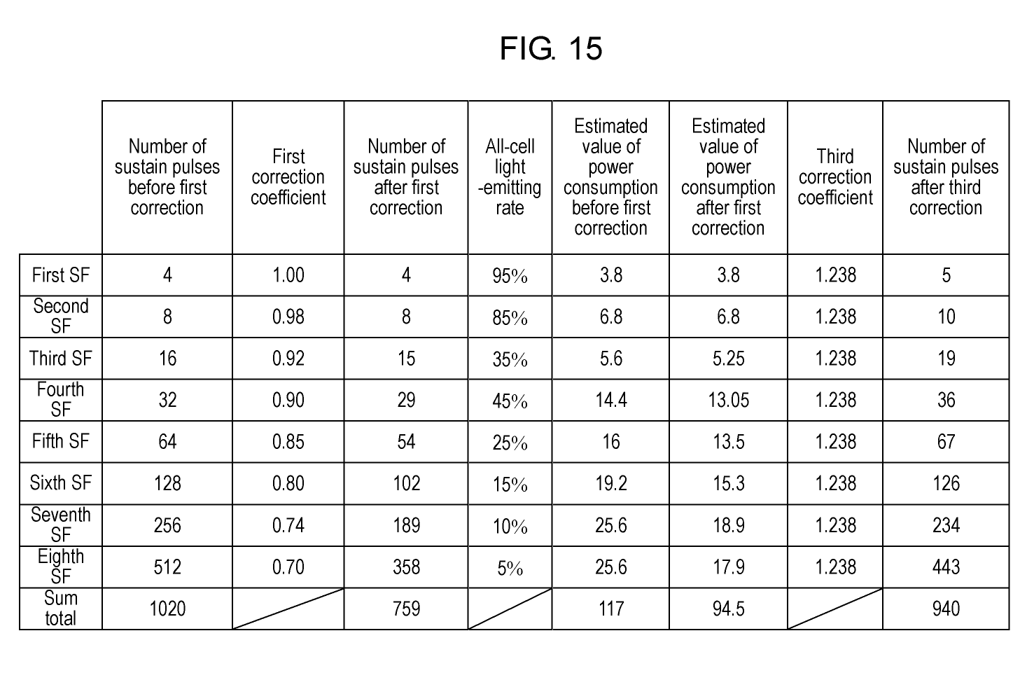

FIG. 15 is a diagram for illustrating “third correction” using a specific numerical value in accordance with the third exemplary embodiment of the present invention. FIG. 15 shows, for each subfield, the number of sustain pulses before “first correction”, “first correction coefficient”, the number of sustain pulses after “first correction”, the all-cell light-emitting rate, the estimated value of the power consumption before “first correction”, the estimated value of the power consumption after “first correction”, “third correction coefficient”, and the number of sustain pulses after “third correction”. For example, it is assumed that the number of sustain pulses generated based on the input image signal and luminance weight is (4, 8, 16, 32, 64, 128, 256, and 512) in the first SF through eighth SF, respectively. It is also assumed that “first correction coefficient” read from look-up table 62 based on the all-cell light-emitting rate and the average value of the partial light-emitting rates is (1.00, 0.98, 0.92, 0.90, 0.85, 0.80, 0.74, and 0.70) in the first SF through eighth SF, respectively. In this case, the number of sustain pulses after “first correction” calculated by after-first-correction number-of-sustain-pulses setting section 63 is (4, 8, 15, 29, 54, 102, 189, and 358) (the fractional portion is rounded) in the first SF through eighth SF, respectively.

It is assumed that the all-cell light-emitting rate is (95%, 85%, 35%, 45%, 25%, 15%, 10%, and 5%) in the first SF through eighth SF, respectively. In this case, the numerical multiplication value calculated by multiplying the number of sustain pulses before “first correction” by the all-cell light-emitting rate with multiplying section 74 is (3.8, 6.8, 5.6, 14.4, 16, 19.2, 25.6, and 25.6) in the first SF through eighth SF, respectively.

Therefore, the total number of these numerical values, namely the numerical value output from sum total calculating section 76, is “117”. The total number (appropriate value) of power consumption in each sustain period when an image is displayed without “first correction” is “117”.

Similarly, the numerical multiplication value calculated by multiplying the number of sustain pulses after “first correction” by the all-cell light-emitting rate with multiplying section 75 is (3.8, 6.8, 5.25, 13.05, 13.5, 15.3, 18.9, and 17.9) in the first SF through eighth SF, respectively.

Therefore, the total number of these numerical values, namely the numerical value output from sum total calculating section 77, is “94.5”. The total number (appropriate value) of power consumption in each sustain period when an image is displayed only through “first correction” is “94.5”.

According to these results, the total number (appropriate value) of power consumption in each sustain period when an image is displayed only through “first correction”, namely “94.5”, is smaller than that when an image is displayed without “first correction”, namely “117”.

Next, third-correction-coefficient calculating section 78 divides “117” calculated by sum total calculating section 76 by “94.5” calculated by sum total calculating section 77, and obtains “third correction coefficient”=“1.238”.

Then, after-third-correction number-of-sustain-pulses setting section 79 multiplies “1.238” obtained as “third correction coefficient” by the numbers (4, 8, 15, 29, 54, 102, 189, and 358) of sustain pulses in the first SF through eighth SF calculated by after-first-correction number-of-sustain-pulses setting section 63.

Thus, the number of sustain pulses generated in each subfield after “third correction” is (5, 10, 19, 36, 67, 126, 234, and 443) (the fractional portion is rounded) in the first SF through eighth SF, respectively. The result obtained by multiplying the number of sustain pulses in each subfield after “third correction” by the all-cell light-emitting rate is (4.75, 8.5, 6.65, 16.2, 16.75, 18.9, 23.4, and 22.15) in the first SF through eighth SF, respectively, and the sum total of these values is “117.3”. Therefore, by “third correction”, the power consumption in one field period can be made equivalent to the power consumption before “first correction”. The total number of sustain pulses in one field can be made larger than that when only “first correction” is performed, so that reduction in brightness of the display image can be prevented to improve the image display quality.

As discussed above, in the present exemplary embodiment, “third correction” capable of making the power consumption in one field period equivalent to the power consumption before “first correction” is performed, in addition to “first correction” of the first exemplary embodiment. Thanks to such a configuration, the linearity of gradation in the display image can be kept and reduction in brightness of the display image can be prevented while increase in power consumption is suppressed.

In the present exemplary embodiment, the estimated value of the power consumption in one field period after “third correction” can be made equivalent to that before “first correction”. Therefore, this configuration can be used for a configuration where the maximum value of the correction coefficients stored on look-up table 62 is larger than “1” and the estimated value of the power consumption in one field period after “first correction” is larger than that before “first correction”.

### Fourth Exemplary Embodiment

In the second exemplary embodiment, the configuration has been described where “second correction” for making the total number of sustain pulses generated in one field period equivalent to that before “first correction” is performed. In this configuration, however, the power consumption after “second correction” can be larger than that before “first correction”.

This is for the following reason: “first correction coefficient” is set for each of subfields as shown in the first exemplary embodiment, and “first correction coefficient” increases as the all-cell light-emitting rate increases or decreases as the all-cell light-emitting rate decreases, as shown in FIG. 10.

Therefore, when the maximum value of “first correction coefficient” is set at “1”, the following phenomenon occurs:
the number of sustain pulses in a subfield (for example, first SF through sixth SF of FIG. 13) of a relatively large “first correction coefficient” as shown in FIG. 13 is slightly smaller than the number of sustain pulses before “first correction”; and
the number of sustain pulses in a subfield (for example, seventh SF and eighth SF of FIG. 13) of a relatively small “first correction coefficient” is significantly smaller than the number of sustain pulses before “first correction”. Here, this phenomenon depends on the method of setting the maximum value of “first correction coefficient”.

When the maximum value of “first correction coefficient” is set at “1”, “first correction coefficient” of each subfield is “1” or smaller. Therefore, the total number of sustain pulses in one field period after “first correction” is not higher than that before “first correction”. As a result, “second correction coefficient” is “1” or larger.

“Second correction coefficient” is set commonly for all subfields in one field as discussed in the second exemplary embodiment. Therefore, in a subfield of a high all-cell light-emitting rate (for example, first SF through sixth SF of FIG. 13), the number of sustain pulses after “second correction” is apt to be larger than that before “first correction”. In a subfield of a low all-cell light-emitting rate (for example, seventh SF and eighth SF of FIG. 13), the number of sustain pulses after “second correction” is apt to be smaller than that before “first correction”.

The number of discharge cells to be lit is larger in a subfield of a high all-cell light-emitting rate than in a subfield of a low all-cell light-emitting rate, so that the electric power consumed by one sustain discharge also increases.

In other words, in a subfield where the electric power consumed by one sustain discharge is large (the all-cell light-emitting rate is high), the number of sustain pulses after “second correction” is apt to be larger than that before “first correction”. In a subfield where the electric power consumed by one sustain discharge is small (the all-cell light-emitting rate is low), the number of sustain pulses after “second correction” is apt to be smaller than that before “first correction”. As a result, it is considered that the power consumption after “second correction” can be larger than that before “first correction”.

However, the power consumption of plasma display apparatus 1 is smaller when the average picture level (APL) of an image signal is low than when the APL is high. Therefore, even if the power consumption is somewhat increased by “second correction”, a significant problem does not occur. In order to improve the image display quality, it is preferable that an image of a low APL can be displayed more brightly. When the APL is high, the power consumption of plasma display apparatus 1 increases, and hence “third correction” capable of preventing reduction in brightness of the display image while suppressing increase in power consumption is more preferable than “second correction” where the power consumption increases.

In the present exemplary embodiment, a configuration is described where “fourth correction” using “fourth correction coefficient” is performed after “first correction” of the first exemplary embodiment. “Fourth correction coefficient” is obtained by mixing “second correction coefficient” and “third correction coefficient” at a ratio corresponding to the magnitude of the APL, and is set commonly for all subfields in one field.

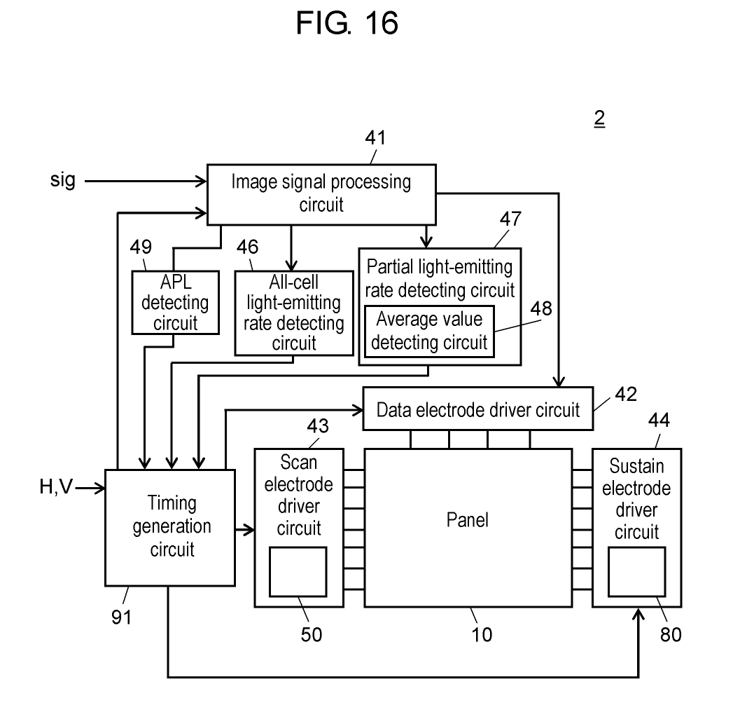

FIG. 16 is a circuit block diagram of plasma display apparatus 2 in accordance with the fourth exemplary embodiment of the present invention.

Plasma display apparatus 2 includes the following elements:
panel 10;
image signal processing circuit 41;
data electrode driver circuit 42;
scan electrode driver circuit 43;
sustain electrode driver circuit 44;
timing generation circuit 91;
all-cell light-emitting rate detecting circuit 46;
partial light-emitting rate detecting circuit 47;
APL detecting circuit 49; and
a power supply circuit (not shown) for supplying power required for each circuit block.
   Configurations and operations of circuit blocks other than APL detecting circuit 49 and timing generation circuit 91 are assumed to be similar to those of the same circuit blocks of FIG. 4 in the first exemplary embodiment.

APL detecting circuit 49 detects the APL using a generally known method of accumulating the luminance value of an input image signal for one field period, and transmits the detection result to timing generation circuit 91.

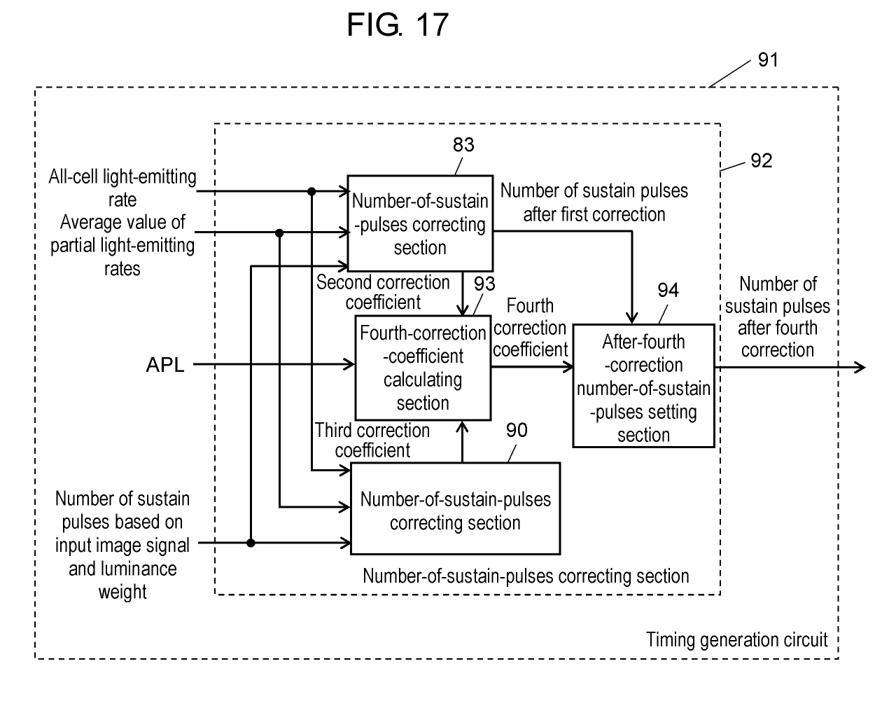

FIG. 17 is a diagram showing a part of circuit blocks of timing generation circuit 91 in accordance with the fourth exemplary embodiment of the present invention. FIG. 17 shows only circuit blocks related to the fourth exemplary embodiment, and the other circuit blocks are omitted.

In FIG. 17, timing generation circuit 91 of the present exemplary embodiment includes number-of-sustain-pulses correcting section 92. Number-of-sustain-pulses correcting section 92 has number-of-sustain-pulses correcting section 83, number-of-sustain-pulses correcting section 90, fourth-correction-coefficient calculating section 93, and after-fourth-correction number-of-sustain-pulses setting section 94. Number-of-sustain-pulses correcting section 83 of FIG. 17 outputs “second correction coefficient”. However, the configuration and operation of number-of-sustain-pulses correcting section 83 of FIG. 17 are similar to those of number-of-sustain-pulses correcting section 83 shown in FIG. 12, and hence are not described. Number-of-sustain-pulses correcting section 90 of FIG. 17 outputs “third correction coefficient”. However, the configuration and operation of number-of-sustain-pulses correcting section 90 of FIG. 17 are similar to those of number-of-sustain-pulses correcting section 90 shown in FIG. 14, and hence are not described.

Fourth-correction-coefficient calculating section 93 mixes “second correction coefficient” output from number-of-sustain-pulses correcting section 83 and “third correction coefficient” output from number-of-sustain-pulses correcting section 90 in response to the APL. Specifically, when the APL is lower than a first threshold (e.g. 20%), “second correction coefficient” is output as “fourth correction coefficient” in order to place a high priority on luminance improvement of a display image. When the APL is not lower than a second threshold (e.g. 30%), which is higher than the first threshold, “third correction coefficient” is output as “fourth correction coefficient” in order to place a high priority on suppression of power consumption. When the APL is the first threshold or higher and lower than the second threshold, “second correction coefficient” and “third correction coefficient” are mixed at a ratio corresponding to the magnitude of the APL, and the mixing result is output as “fourth correction coefficient”.

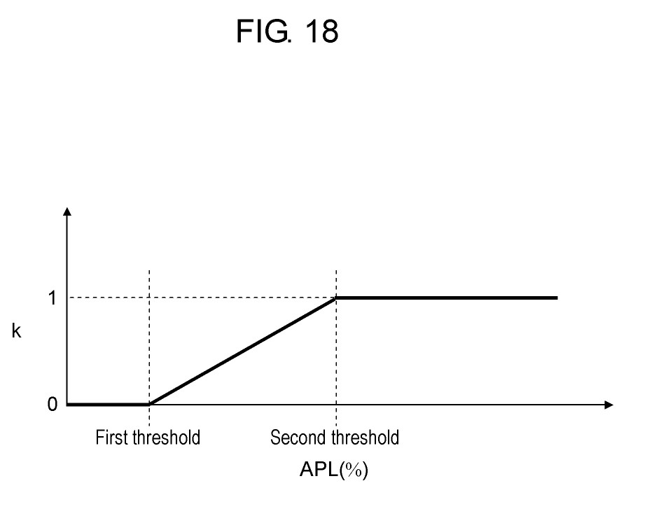

As a method of calculating “fourth correction coefficient”, for example, a method using variable k can be used. FIG. 18 is a diagram showing one example of setting of variable k in accordance with the fourth exemplary embodiment of the present invention. In FIG. 18, the horizontal axis shows the APL, and the vertical axis shows variable k.

For example, k=“0” when the APL is lower than the first threshold, k=“1” when the APL is not lower than the second threshold, and k=(APL−first threshold)/(second threshold−first threshold) when the APL is the first threshold or higher and lower than the second threshold.

Then, “fourth correction coefficient” is calculated by substituting variable k obtained from the above-mentioned calculation equation into the following calculation equation:

“fourth correction coefficient”=(1−k)×“second correction coefficient”+k×“third correction coefficient”.

For example, such a calculation method can be used as one example of a method of calculating “fourth correction coefficient”.

In the present invention, however, the method of calculating “fourth correction coefficient” is not limited to the above-mentioned method. “Fourth correction coefficient” may be calculated in another method, for example, by raising variable k to the power of 2 or raising variable k to the power of ½.

After-fourth-correction number-of-sustain-pulses setting section 94 multiplies the number of sustain pulses after first correction output from after-first-correction number-of-sustain-pulses setting section 63 (not shown in FIG. 17) by “fourth correction coefficient” output from fourth-correction-coefficient calculating section 93, and outputs the multiplication result as the number of sustain pulses after fourth correction.

Then, timing generation circuit 91 generates a timing signal for controlling each circuit block so that, in each subfield, as many sustain pulses as the number of sustain pulses after fourth correction output from after-fourth-correction number-of-sustain-pulses setting section 94 are output from sustain pulse generation circuit 50 and sustain pulse generation circuit 80.

As discussed above, in the present exemplary embodiment, when the APL of the input image signal is low (APL is lower than the first threshold), “second correction” that places a high priority on the brightness of the display image is performed in addition to “first correction” of the first exemplary embodiment. When the APL of the input image signal is high (APL is the second threshold or higher), “third correction” capable of preventing the reduction in brightness of the display image while suppressing the increase in power consumption is performed. When the APL is the first threshold or higher and lower than the second threshold, “fourth correction” is performed where “fourth correction coefficient” is obtained by mixing “second correction coefficient” and “third correction coefficient” at a ratio corresponding to the magnitude of the APL. In such a configuration, the linearity of the gradation in the display image can be kept, and the reduction in brightness of the display image can be prevented while the increase in power consumption is suppressed.

### Fifth Exemplary Embodiment

In the third exemplary embodiment, the following configuration has been described: after “first correction” of the first exemplary embodiment, “third correction” that makes the estimated value of the power consumption in one field period equivalent to that before “first correction” is performed. The configuration has been also described where, in each subfield, the number of sustain pulses is multiplied by the all-cell light-emitting rate, the sum total of the multiplication results in one field period is calculated, thereby calculating the estimated value of the power consumption in one field period. However, the estimated value of the power consumption can be calculated at an increased accuracy, and the accuracy of “third correction” can be increased. In the fifth exemplary embodiment, a configuration where the accuracy of the estimated value of the power consumption is further increased is described.

Correction using “third correction coefficient” is a correction commonly set for each subfield, and “third correction coefficient” is “common correction coefficient” used commonly for each subfield.

When panel 10 is driven, electric power generally called “reactive power” that is consumed ineffectively without contributing on the light emission is generated. This reactive power is considered to be generated by the following factor, for example:
electric power consumed by parasitic resonance or parasitic capacity caused in a wire for electrically connecting sustain electrode driver circuit 44 to sustain electrodes 23; or
current (dark current) flowing in a discharge cell by voltage difference caused in the discharge cell regardless of occurrence of discharge.
   The reactive power varies dependently on the number of generated sustain pulses.

In the present exemplary embodiment, offset value OFST based on the reactive power is set, and an estimated value of power consumption is calculated using offset value OFST. Specifically, offset value OFST preset for the all-cell light-emitting rate in each subfield is added. The addition result is multiplied by the number of sustain pulses in each subfield, and the sum total of the multiplication results in one field period is calculated. Thus, the estimated value of power consumption in one field period is calculated. Thus, the estimated value of the power consumption can be calculated in consideration of the reactive power, and the accuracy of the estimated value of power consumption can be increased.

In the present exemplary embodiment, offset value OFST based on the reactive power is set as below.

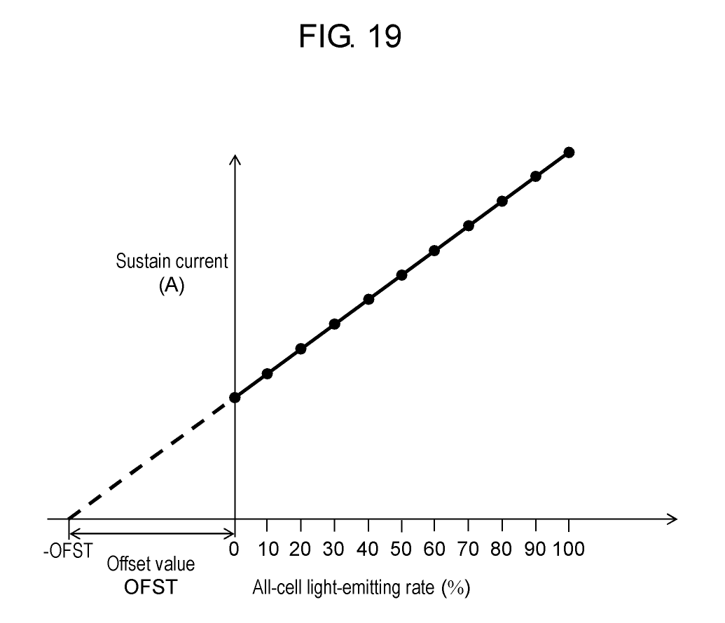

FIG. 19 is a characteristic diagram showing the relationship between the all-cell light-emitting rate and sustain current of plasma display apparatus 1. In FIG. 19, the horizontal axis shows the all-cell light-emitting rate, and the vertical axis shows the sustain current. The sustain current means the current flowing from sustain electrode driver circuit 44 to sustain electrodes 23.

When the characteristics of FIG. 19 are measured, the so-called window pattern is used as an image displayed on panel 10. This window pattern means an image where a square region of a luminance level of 100% is displayed in the background of a luminance level of 0% and the area of the region can be altered. The sustain current is measured while the area of the region of a luminance level of 100% is altered from 100% to 0% of the image display surface of panel 10 at an interval of 10%, for example. Thus, the relationship between the all-cell light-emitting rate and sustain current is measured.

Next, the measurement result is plotted on the graph of FIG. 19, in which the horizontal axis shows the all-cell light-emitting rate and the vertical axis shows the sustain current. There is a proportionality between the all-cell light-emitting rate and sustain current, so that the measurement result is plotted in a substantially linear shape as shown in the solid line of FIG. 19. At this time, thanks to the effect of the reactive power, the sustain current does not become “0” even when the all-cell light-emitting rate is 0 (%).

Next, the straight line obtained by plotting is extended until it crosses the horizontal axis. This extended line is shown by a broken like, and the intersection point of the extended line and the horizontal axis is denoted as “-OFST”. The intersection point of the extended line and the horizontal axis can be considered as a rough estimated value obtained by converting the reactive power into the all-cell light-emitting rate. In the present exemplary embodiment, the absolute value of the intersection point is used as offset value OFST.

For example, when the intersection point exists at a position of “−30%” on the horizontal axis, offset value OFST is “30%”. In the present exemplary embodiment, the offset value is set in this manner.

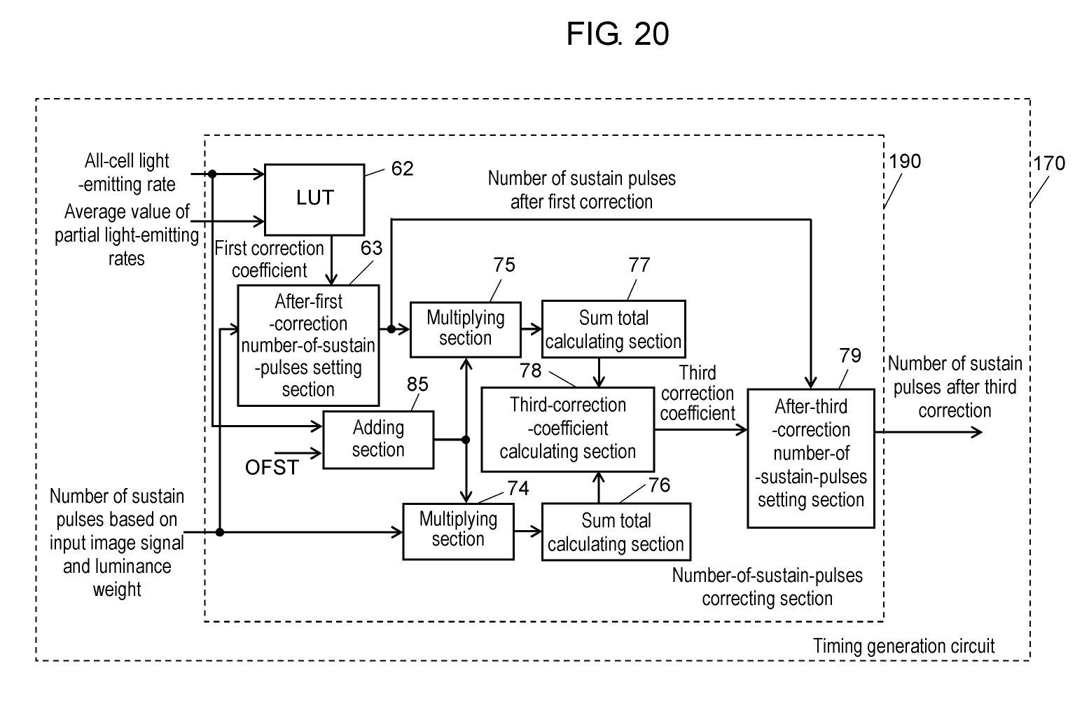

FIG. 20 is a diagram showing a part of circuit blocks of timing generation circuit 170 in accordance with the fifth exemplary embodiment of the present invention. Timing generation circuit 170 of the present exemplary embodiment has number-of-sustain-pulses correcting section 190. Number-of-sustain-pulses correcting section 190 of FIG. 20 differs from number-of-sustain-pulses correcting section 90 of FIG. 14 in that number-of-sustain-pulses correcting section 190 has adding section 85 for adding offset value OFST to the all-cell light-emitting rate. The configuration and operation of each of the other circuit blocks are similar to those of number-of-sustain-pulses correcting section 90. In FIG. 20, the circuit blocks for performing operations similar to those of number-of-sustain-pulses correcting section 90 are denoted with the same reference marks as the reference marks of FIG. 14, and the descriptions of those circuit blocks are omitted.

Adding section 85 adds offset value OFST previously determined by the above-mentioned method to the all-cell light-emitting rate detected by all-cell light-emitting rate detecting circuit 46. The addition result is output to multiplying section 74 and multiplying section 75.

Multiplying section 74 multiplies the number of sustain pulses in each subfield set based on the input image signal and luminance weight by the result obtained by adding the offset value OFST to the all-cell light-emitting rate of the subfield. Thus, in the present exemplary embodiment, the estimated value of the power consumption in each sustain period when an image is displayed without “first correction” can be calculated as an accurate estimated value considering the reactive power.

Multiplying section 75 multiplies the number of sustain pulses after “first correction” in each subfield output from after-first-correction number-of-sustain-pulses setting section 63 by the result obtained by adding the offset value OFST to the all-cell light-emitting rate of the subfield. Thus, in the present exemplary embodiment, the estimated value of the power consumption in each sustain period when an image is displayed only through “first correction” can be calculated as an accurate estimated value considering the reactive power.

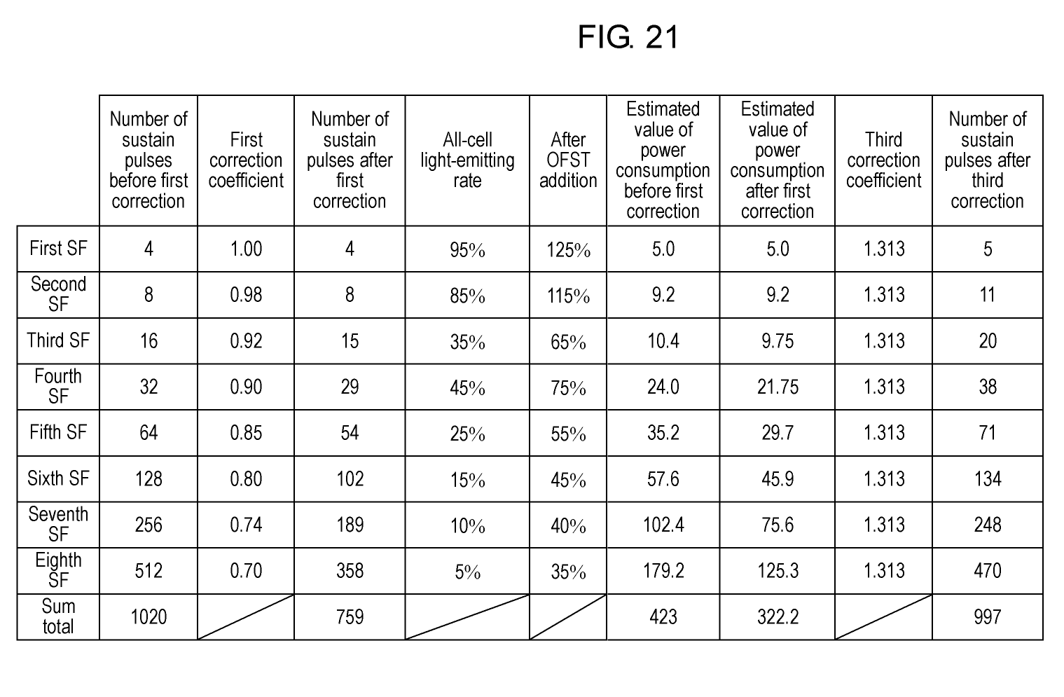

FIG. 21 is a diagram for illustrating one example of more accurate “third correction” using a specific numerical value in accordance with the fifth exemplary embodiment of the present invention. FIG. 21 shows, in each subfield, the number of sustain pulses before “first correction”, “first correction coefficient”, the number of sustain pulses after “first correction”, the all cell light emitting rate, the result obtained by adding offset value OFST to the all-cell light-emitting rate (hereinafter, referred to as “after OFST addition”, and “after OFST addition” in FIG. 21), the estimated value of the power consumption before “first correction”, the estimated value of the power consumption after “first correction”, “third correction coefficient”, and the number of sustain pulses after “third correction”. In the example of FIG. 21, each numerical value of the number of subfields, the number of sustain pulses in each subfield, “first correction coefficient”, and “third correction coefficient” is similar to each numerical value of FIG. 15.

For example, it is assumed that offset value OFST is 30%, and the all-cell light-emitting rate is (95%, 85%, 35%, 45%, 25%, 15%, 10%, and 5%) in the first SF through eighth SF, respectively. In this case, the numerical values “after OFST addition” are (125%, 115%, 65%, 75%, 55%, 45%, 40%, and 35%). Therefore, the numerical multiplication value calculated by multiplying the number of sustain pulses before “first correction” by “after OFST addition” is (5.0, 9.2, 10.4, 24.0, 35.2, 57.6, 102.4, and 179.2) in the first SF through eighth SF, respectively.

Therefore, the sum total of them, namely the numerical value output from sum total calculating section 76, is “423”. In other words, the sum total (estimated value considering reactive power) of the power consumption in each sustain period when an image is displayed without “first correction” is “423”.

Similarly, the numerical multiplication value calculated by multiplying the number of sustain pulses after “first correction” by “after OFST addition” with multiplying section 75 is (5.0, 9.2, 9.75, 21.75, 29.7, 45.9, 75.6, and 125.3) in the first SF through eighth SF, respectively.

Therefore, the sum total of them, namely the numerical value output from sum total calculating section 77, is “322.2”. In other words, the sum total (estimated value considering reactive power) of the power consumption in each sustain period when an image is displayed only through “first correction” is “322.2”.

According to these results, the sum total (estimated value considering reactive power) of the power consumption in each sustain period when an image is displayed only through “first correction”, namely “322.2”, is smaller than that when an image is displayed without “first correction”, namely “423”. These estimated values of power consumption are numerical values calculated in consideration of the reactive power as discussed above, and hence are more accurate than the similar numerical values of the third exemplary embodiment. Next, third-correction-coefficient calculating section 78 divides “423” calculated by sum total calculating section 76 by “322.2” calculated by sum total calculating section 77, and obtains “third correction coefficient”=“1.313”.

Then, after-third-correction number-of-sustain-pulses setting section 79 multiplies “1.313” obtained as “third correction coefficient” by the numbers (4, 8, 15, 29, 54, 102, 189, and 358) of sustain pulses in the first SF through eighth SF calculated by after-first-correction number-of-sustain-pulses setting section 63.

Thus, the number of sustain pulses generated after “third correction” is (5, 11, 20, 38, 71, 134, 248, and 470) (the fractional portion is rounded) in the first SF through eighth SF, respectively. The result obtained by multiplying the number of sustain pulses in each subfield after “third correction” by each numerical value of “after offset addition” is (6.25, 12.65, 13, 28.5, 39.05, 60.3, 99.2, and 164.5) in the first SF through eighth SF, respectively, and the sum total of these values is “423.45” (not shown). Therefore, the estimated value of the power consumption in one field period after “third correction” becomes substantially equivalent to that before “first correction”.

In the present exemplary embodiment, when “third correction” is performed, an estimated value of power consumption is calculated in each subfield using offset value OFST set based on the reactive power, as discussed above. Thanks to such a configuration, the estimated value of power consumption can be calculated at an increased accuracy, and the accuracy of “third correction” can be further increased.

The exemplary embodiments of the present invention can be applied to a panel driving method by the so-called two-phase drive. In this driving method, scan electrode SC1 through scan electrode SCn are classified into a first scan electrode group and a second scan electrode group, and the address period is constituted by a first address period and a second address period. Here, in the first address period, a scan pulse is applied to each scan electrode belonging to the first scan electrode group. In the second address period, a scan pulse is applied to each scan electrode belonging to the second scan electrode group. Also in this case, an effect similar to the above-mentioned effect can be produced.

The exemplary embodiments of the present invention are also useful for a panel having an electrode structure where a scan electrode is adjacent to another scan electrode and a sustain electrode is adjacent to another sustain electrode, namely an electrode structure (referred to as “ABBA electrode structure”) where the electrode array disposed on the front substrate is “ . . . , scan electrode, scan electrode, sustain electrode, sustain electrode, scan electrode, scan electrode, . . . ”.

Each circuit block shown in the exemplary embodiments of the present invention may be configured as an electric circuit for performing each operation shown in the exemplary embodiments, or may be configured using a microcomputer or the like programmed so as to perform a similar operation.

In the exemplary embodiments of the present invention, an example where one pixel is formed of discharge cells of three colors R, G, and B has been described. However, also in a panel where one pixel is formed of discharge cells of four or more colors, the configurations shown in the present exemplary embodiments can be applied and a similar effect can be produced.

Each specific numerical value shown in the exemplary embodiments of the present invention is set based on the characteristics of panel 10 having a screen size of 50 inches and having 1080 display electrode pairs 24, and is simply one example in the embodiments. The present invention is not limited to these numerical values. Numerical values are preferably set optimally in response to the characteristics of the panel or the specification of the plasma display apparatus. These numerical values can vary in a range allowing the above-mentioned effect. The number of subfields and the luminance weight of each subfield are not limited to the values shown in the exemplary embodiments of the present invention, but the subfield structure may be changed based on an image signal or the like.

### INDUSTRIAL APPLICABILITY

Even in a panel where the screen is enlarged and the definition is enhanced, the variation in luminance weight caused in each subfield can be estimated accurately, the linearity of the gradation in the display image can be kept, and reduction in brightness of the display image can be prevented, so that the image display quality can be improved. Therefore, the present invention is useful as a plasma display apparatus and a driving method of a panel.

### REFERENCE MARKS IN THE DRAWINGS

1, 2 plasma display apparatus
10 panel
21 front substrate
22 scan electrode
23 sustain electrode
24 display electrode pair
25, 33 dielectric layer
26 protective layer
31 rear substrate
32 data electrode
34 barrier rib
35 phosphor layer
41 image signal processing circuit
42 data electrode driver circuit
43 scan electrode driver circuit
44 sustain electrode driver circuit
45, 60, 70, 91, 170 timing generation circuit
46 all-cell light-emitting rate detecting circuit
47 partial light-emitting rate detecting circuit
48 average value detecting circuit
49 APL detecting circuit
50, 80 sustain pulse generation circuit
51, 81 power recovery circuit
52, 82 clamping circuit
53 initializing waveform generation circuit
54 scan pulse generation circuit
61, 83, 90, 92, 190 number-of-sustain-pulses correcting section
62 look-up table
63 after-correction number-of-sustain-pulses setting section (after-first-correction number-of-sustain-pulses setting section)
68 after-first-correction number-of-sustain-pulses summarizing section
69 before-correction number-of-sustain-pulses summarizing section
71 second-correction-coefficient calculating section
72 switch
73 after-second-correction number-of-sustain-pulses setting section
74, 75 multiplying section
76, 77 sum total calculating section
78 third-correction-coefficient calculating section
79 after-third-correction number-of-sustain-pulses setting section
85 adding section
93 fourth-correction-coefficient calculating section
94 after-fourth-correction number-of-sustain-pulses setting section Q11, Q12, Q13, Q14, Q21, Q22, Q23, Q24, Q26, Q27, Q28, Q29, QH1 through QHn, QL1 through QLn switching element
C10, C20, C30 capacitor
L10, L20 inductor
D11, D12, D21, D22, D30 diode

1. A plasma display apparatus comprising:
a plasma display panel having a plurality of discharge cells where a plurality of subfields having a luminance weight is disposed in one field and as many sustain pulses as a number corresponding to the luminance weight are applied in a sustain period of each of the subfields to emit light;
an image signal processing circuit for converting an input image signal into image data indicating light emission or no light emission in each subfield in the discharge cells;
a sustain pulse generation circuit that generates as many sustain pulses as the number corresponding to the luminance weight in the sustain period, and applies the sustain pulses to the discharge cells;
an all-cell light-emitting rate detecting circuit for detecting, as an all-cell light-emitting rate, which is a ratio of the number of discharge cells to be lit to a total number of discharge cells on an image display surface of the plasma display panel in each subfield;
a partial light-emitting rate detecting circuit that divides the image display surface of the plasma display panel into a plurality of regions and detects, as a partial light-emitting rate, which is a ratio of the number of discharge cells to be lit to the number of discharge cells in each of the regions in each subfield; and
a timing generation circuit that has a number-of-sustain-pulses correcting section for controlling the number of sustain pulses generated by the sustain pulse generation circuit and generates a timing signal for controlling the sustain pulse generation circuit,
wherein the number-of-sustain-pulses correcting section has a look-up table on which a plurality of correction coefficients is previously stored in association with the all-cell light-emitting rate and the partial light-emitting rates,
wherein the number-of-sustain-pulses correcting section corrects the number of generated sustain pulses set for each subfield based on the input image signal and the luminance weight by using a first correction coefficient and a common correction coefficient, the first correction coefficient being read from the look-up table in response to the all-cell light-emitting rate and the partial light-emitting rates and being set for each subfield, the common correction coefficient being set based on the first correction coefficient, and
wherein the number-of-sustain-pulses correcting section adds a preset offset value to the all-cell light-emitting rate in each subfield, multiplies the addition result by the number of sustain pulses in each subfield, calculates a sum total of the multiplication results in one field period to calculate an estimated value of a power consumption in one field period, and sets the common correction coefficient so that the estimated values of the power consumption in one field period before correction and after the correction can be equivalent to each other, the correction using the first correction coefficient and the common correction coefficient.

2. A driving method of a plasma display panel emits light in discharge cells by disposing a plurality of subfields. each of which has a luminance weight in one field and applying as many sustain pulses as a number corresponding to the luminance weight to the discharge cells in the sustain period, the driving method comprising:
detecting, as an all-cell light-emitting rate, which is a ratio of the number of discharge cells to be lit to a total number of discharge cells on an image display surface of the plasma display panel in each subfield, dividing the image display surface of the plasma display panel into a plurality of regions, and detecting, as a partial light-emitting rate, which is a ratio of the number of discharge cells to be lit to the number of discharge cells in each of the regions in each subfield;
correcting the number of generated sustain pulses set for each subfield based on an input image signal and the luminance weight by using a first correction coefficient that is determined based on the all-cell light-emitting rate and the partial light-emitting rates and a common correction coefficient that is set based on the first correction coefficient;
adding a preset offset value to the all-cell light-emitting rate in each subfield, multiplying the addition result by the number of sustain pulses in each subfield, and calculating a sum total of the multiplication results in one field period to calculate an estimated value of a power consumption in one field period; and
setting the common correction coefficient so that the estimated values of the power consumption in one field period before correction and after the correction are equivalent to each other, the correction using the first correction coefficient and the common correction coefficient.
